(19) United States
(12) Patent Application Publication
(10) Pub. No.: US 2025/0068810 A1
(43) Pub. Date: Feb. 27, 2025

(54) GENERATION OF 3-D SHAPES FOR EDA OPERATIONS

(71) Applicant: D2S, Inc., San Jose, CA (US)

(72) Inventors: Donald Oriordan, Sunnyvale, CA (US); Akira Fujimura, Saratoga, CA (US)

(21) Appl. No.: 18/814,446

(22) Filed: Aug. 23, 2024

Related U.S. Application Data
(60) Provisional application No. 63/669,384, filed on Jul. 10, 2024.
(60) Provisional application No. 63/608,145, filed on Dec. 8, 2023.
(60) Provisional application No. 63/534,141, filed on Aug. 23, 2023.

(51) Int. Cl. G06F 30/31; G06N 3/08

(52) U.S. Cl. CPC G06F 30/31; G06N 3/08

(57) ABSTRACT

Some embodiments provide a method for performing an electronic design automation (EDA) operation with respect to a circuit component that is defined on a layer of an EDA design layout. The layer is defined by (i) a plane defined along x- and y-axes and (ii) having a thickness along a z-axis. The method uses a wafer shape simulator to generate multiple two dimensional (2-D) shapes for the circuit component with each 2D shape representing a different predicted manufactured cross x-y section of the component at a different location along the z-axis. The method uses the 2-D shapes to generate, for the circuit component, a predicted-as-manufactured three dimensional (3-D) shape that deviates along the z-axis. The method performs an EDA operation for the circuit component using the predicted-as-manufactured 3-D shape.

### BACKGROUND

Wiring on integrated circuits (ICs) is modeled as interconnect lines in typical electronic design automation (EDA) tools. While it is conventional to think of interconnect wires as having rectangular cross sections, the actual as-manufactured interconnect shapes have effectively tapered (e.g., trapezoidal) cross sections. FIG. 1 illustrates an example of cross-sectional scanning electron microscopy (SEM) images of chips from Intel's 22 nm and 14 nm processes that shows the trapezoidal nature of the cross section. To extract the capacitance of such conductors with the highest level of accuracy, this trapezoidal cross section is included in the structures which are passed to an electromagnetic (EM) solver. The shapes of the trapezoidal cross sections themselves may vary at different manufacturing process conditions, with some process conditions having “steeper” or “shallower” side angles than others, adding further complications. Additionally, electrical interconnect segments may be drawn as rectangular shapes in the XY plane by a layout designer, but when manufactured, become curvilinear.

FIG. 2 illustrates an example of layout-drawn shapes (cross-hatched) of interconnect wires and their corresponding manufactured curvilinear shapes at different process conditions. Determining the curvilinear shapes of interconnect wires at the various process conditions can be performed by manufacturing an IC and then inspecting it (e.g., under a scanning electron microscope), a process which would be prohibitively expensive. Alternatively, manufacturing process simulators may be used to run CPU-intensive physics-based models and simulations to determine the manufactured curvilinear shapes of the interconnect wires. This process may be very slow.

### BRIEF SUMMARY

Some embodiments provide a method (performed, e.g., by a layout verification tool) that computes parasitic parameters for a design layout that defines a design for a region of an integrated circuit (IC). In some embodiments, the method identifies a set of conductive circuit components (e.g., interconnect wires, z-axis connections such as vias or contacts) in a layer of a design layout. These conductive circuit components traverse within a plane defined for the layer (e.g., an x-y plane) and have a thickness orthogonal to that plane (e.g., in the z-axis direction). The method computes, for each of the components, a set of one or more predicted manufactured shapes that have tapered cross sections in the direction orthogonal to the plane (e.g., trapezoidal cross sections rather than rectangular as would be the case for non-tapered cross sections). The method uses these predicted manufactured shapes to compute parasitic values that express parasitic effects of the conductive circuit components (e.g., parasitic coupling capacitance values).

In some embodiments, the design layout is a design layout for a wire structure that is to be manufactured on a substrate, such as a silicon wafer. In some such embodiments, the wire structure includes several interconnect wire segments (e.g., a type of conductive circuit components) that have rectilinear shapes (i.e., the shapes are produced by using straight line segments). However, at least some of the predicted manufactured shapes for the interconnect wire segments have curvilinear shapes (i.e., include at least one curved line segment), owing to the tendency of actual manufacturing processes to produce wire segments with curvilinear features. In some embodiments, the design layout itself may include curvilinear shapes (e.g., entirely curvilinear shapes, or a combination of shapes with curvilinear and rectilinear edges).

The method, in some embodiments, initially uses the two-dimensional (2-D) design layout of the layer to generate a 2-D predicted manufactured shape for each conductive circuit component (or for the design layout region as a whole), then uses information about the component thickness and the taper angle to generate a three-dimensional (3-D) predicted manufactured shape for each conductive circuit component. These 3-D predicted manufactured shapes can then be used to accurately compute parasitic parameters for the components of the layout. Using the taper angles so that the 3-D predicted manufactured shapes more closely resemble the components as they will actually be manufactured on a substrate (as compared to the sides of the 3-D shapes being orthogonal to the plane of the 2-D shapes) results in more accurate parasitic parameter calculations.

The taper angle, in some embodiments, is defined by a manufacturing process technology file that specifies various aspects of the manufacturing process, including the expected taper angle that will result from the manufacturing of the conductive components on the substrate. The taper angle is the result of how light penetrates through the mask(s) during the manufacturing process, forming slightly tapered sides of the conductive circuit components rather than perfectly rectangular sides.

In some embodiments, different variations in the manufacturing process result in (1) different curvilinear 2-D shapes for the conductive circuit components and/or (2) different taper angles for the cross sections. In addition, the taper angles for one manufacturing process variation can vary based on how different the 2-D shape for that process variation is compared to the shape for an average manufacturing process. Furthermore, some embodiments specify different thicknesses (wire heights) for different manufacturing process conditions. These different manufacturing process variations can be the result of different dosages used during mask-making in some embodiments. Alternatively, or conjunctively, the different manufacturing process variations can be the result of different depths of focus and/or exposure strengths used when shining light through the mask to produce the conductive circuit components of the design layout layer on the wafer.

As such, some embodiments compute multiple different predicted manufactured 3-D shapes for each conductive circuit component and use the multiple shapes to calculate the parasitic parameters. For instance, some embodiments compute, for each conductive circuit component, at least (1) a first predicted manufactured shape relating to a maximum variation of the manufacturing process (a maximum process condition set), (2) a second predicted manufactured shape relating to a minimum variation of the manufacturing process (a minimum process condition set), and (3) a third predicted manufactured shape relating to a nominal variation (e.g., a mean or median) manufacturing process (a nominal process condition set). In such embodiments, the nominal variation represents the average (e.g., mean or median) of the manufacturing process (e.g., a specific manufacturing process parameter or the overall manufacturing process), while the maximum and minimum variations represent extreme variations of the manufacturing process. These extreme variations may represent the most extreme variations possible, a particular percentage of the most extreme variations, or a particular number of standard deviations from the nominal process condition set.

The 2-D predicted manufactured shapes, in some embodiments, are generated from the design layout by inputting the design layout into a machine-trained network (e.g., a neural network) trained to generate predicted manufactured shapes (e.g., curvilinear shapes) for conductive circuit components from design layouts (e.g., having rectilinear and/or curvilinear shapes) for those conductive circuit components. To account for the different manufacturing process variations, some embodiments train different networks (e.g., neural networks having the same network structure but with different trained weights) for each of multiple different manufacturing process condition sets, such as the nominal, maximum, and minimum process condition sets described above. Other embodiments train a single network to generate multiple outputs for a single design layout layer input (e.g., for the three different processing condition sets described above).

From these 2-D shapes (e.g., shapes in an x-y plane), the method of some embodiments applies the taper angles to generate the 3-D shapes. In some embodiments, for each conductive circuit component, the method generates a second shape that is based on the first (e.g., neural network-generated) shape. If the first shape is in the x-y plane, this second shape is parallel to the x-y plane and located a distance away specified by the thickness. In some embodiments, the second shape is a scaled up (or down) version of the first shape, while in other embodiments (if the taper angle varies at different locations), the second shape may be a distorted version of this first shape. The second shape is based on (i) the distance from the first shape that is the specified thickness of the components and (ii) the consistent taper angle or varying (e.g., location-specific) taper angles. The first and second shapes then form the top and bottom surfaces (or bottom and top surfaces) of the 3-D predicted manufactured shape to be used for the parasitic calculations. The method connects the two shapes to form the sidewalls of the 3-D predicted manufactured shape.

Rather than generating the first 2-D shape using a machine-trained network (MTN) and then generating the second 2-D shape via a post-processing operation, some embodiments train an MTN to directly output two or more 2-D shapes (i.e., at different z-axis values, such as the top and bottom of the eventual 3-D shape. These 2-D shapes will typically have similar shapes but with one shape slightly larger than the other to account for the tapering. In this case, the post-processing operation generates a 3-D shape by directly connecting the two or more 2-D shapes.

In different embodiments, as noted, the taper angle may be a constant value (e.g., a factor of the process condition set for a given shape) or varied. For instance, some embodiments compute the taper angle at each location within the x-y plane of the layer (e.g., for each pixel or for each point along a contour, depending on the representation of the shapes). For instance, some embodiments use a constant taper angle for the nominal process conditions and then vary the taper angle for the minimum and maximum process conditions as a function of the distance between the 2-D shapes for the nominal and minimum/maximum process conditions at each location. Other embodiments calculate the taper angle for each location as a function of dose margin and depth of focus measures at that location (information that can be determined from an inverse lithography technology (ILT) mask optimization process).

Other embodiments provide the design layout (and, optionally, the interconnect thickness) to a machine-trained network that directly outputs a (tapered) 3-D predicted manufactured shape for use in the parasitic calculations (e.g., as a set of voxels or as a set of 3-D contours). In some such embodiments, the network is trained using tapered shapes as ground-truth outputs for design layout inputs, such that the 3-D shapes output by the network will have tapered sides. Still other embodiments provide the design layout, thickness information, and taper angles to the machine-trained network, which directly outputs a 3-D predicted manufactured shape for use in the parasitic calculations. In either case, again, different machine-trained networks may be used to account for the different process variations in order to generate different 3-D predicted manufactured shapes for the different manufacturing process condition sets. Irrespective of whether the machine-trained network outputs 2-D or 3-D shapes, the network is trained using known inputs (i.e., design layouts) and known outputs for those inputs (actual manufactured 2-D or 3-D shapes based on the design layout inputs).

In some embodiments, as noted, the predicted manufactured shape for a conductive circuit component tapers by different amounts at different locations. In some embodiments, this variation in taper angles is due to a set of neighboring conductive circuit components. Different types and/or proximities of these neighboring conductive circuit components can result in different taper angle variations for a given conductive circuit component shape. In addition, the set of neighboring conductive circuit components that affect the taper angle can be the same set of neighboring conductive circuit components or a different set of neighboring conductive circuit components than the set of conductive circuit components with respect to which the parasitic effects are computed for a given conductive circuit component.

As noted, the method of some embodiments computes parasitic parameters based on the 3-D predicted manufactured shapes generated for the conductive circuit components. Some embodiments compute parasitic parameters for each manufacturing process condition set based on the 3-D predicted manufactured shapes generated for each of those condition sets. These computed parasitic parameters can then be averaged or otherwise used in combination (e.g., taking the worst value for each parameter) to verify the design layout.

The computed parasitic parameters in different embodiments can be unwanted parasitic capacitance, parasitic resistance, and/or parasitic inductance values on the components. These different parasitic effects can impact circuit delay, energy consumption, and/or power distribution of the manufactured IC. They can also introduce noise sources and other effects that impact reliability. To evaluate the effect of interconnect parasitics on circuit performance, they need to be accurately modeled. Examples of the parasitic parameter include unwanted parasitic resistance of inductance effects on the wire structure.

In some embodiments, the method uses a field solver, such as an electromagnetic (EM) solver, to compute the parasitic value. In such embodiments, the method defines each 3-D predicted manufactured shape as a set of surface panels that can be provided to the field solver. The method then provides each set of surface panels computed for each predicted manufactured shape to the EM solver to compute the required parasitic values (e.g., capacitance values between pairs of 3-D manufactured shapes representing interconnects). The method may provide all of the 3-D as-manufactured shapes at once to the field solver or provide a subset of the shapes (e.g., all of the shapes in a specific region) to the field solver. In some embodiments, the method additionally translates the sets of surface panels into a format readable by the EM solver before supplying the translated sets of surface panels to the EM solver. In the case that an MTN directly outputs a voxel-based 3-D predicted manufactured shape, different embodiments may translate this to a geometric set of surface panels (e.g., using coordinates) or directly provide the voxel-based shape to the EM field solver.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example of cross-sectional SEM images of chips from Intel's 22 nm and 14 nm processes.

FIG. 2 illustrates an example of layout-drawn shapes of interconnect wires and their corresponding manufactured curvilinear shapes at different process conditions.

FIG. 3 illustrates an example of 3-D structures used by an EM solver for interconnect extraction.

FIG. 4 illustrates an example of a trapezoidal cross section of an IC component with a 20-degree taper angle after manufacturing.

FIG. 5 illustrates an example of a scan flop standard cell library element of some embodiments.

FIG. 6 illustrates an example of a scan flop standard cell library element of some embodiments with as-manufactured shapes drawn for a set of design layout shapes.

FIG. 7 illustrates an example of a scan flop design 3-D model surface mesh for the top surface of IC components.

FIG. 8 illustrates an example of a 3-D model surface mesh for a single conductor showing all surfaces from a plan view.

FIG. 9 illustrates an example of a 3-D model surface mesh for a single conductor showing all surfaces from an oblique view.

FIG. 10 illustrates a capacitance matrix for an IC component with a 6-degree taper angle.

FIG. 11 illustrates a capacitance matrix for the same IC component with a 4-degree taper angle.

FIG. 12 conceptually illustrates a process of some embodiments for generating detailed capacitances.

FIG. 13 conceptually illustrates a process 1300 of some embodiments for generating capacitance values using a solver.

FIG. 14 illustrates regions in which taper angles vary significantly due to greater or less change from the nominal 2-D plane shape of IC components to the maximum and minimum 2-D plane shapes of these IC components.

FIG. 15 conceptually illustrates a process of some embodiments for performing parasitic extraction.

FIG. 16 illustrates an example of a predicted manufactured 2-D shape for an interconnect wire segment.

FIG. 17 illustrates three predicted 2-D plane shapes of the same wire segment that are computed to represent the shape of the wire segment in the x-y plane at different manufacturing process variations.

FIG. 18 illustrates three example predicted 3-D manufactured shapes of a same wire segment at different manufacturing variations.

FIG. 19 conceptually illustrates a process of some embodiments for generating 3-D predicted manufactured shapes by initially generating a 2-D predicted manufactured shape for each interconnect wire segment and using taper angles to generate the 3-D predicted manufactured shapes.

FIG. 20 conceptually illustrates the use of a machine-trained network to generate 2-D planar shapes and then taper angle information to generate 3-D shapes.

FIG. 21 conceptually illustrates multiple networks, each trained to generate a different set of outputs for a different set of process conditions corresponding to different manufacturing parameters.

FIG. 22 conceptually illustrates a process of some embodiments for generating 3-D predicted manufactured shapes by initially generating multiple 2-D predicted manufactured shape for each interconnect wire segment and connecting these 2-D shapes to generate the 3-D predicted manufactured shapes.

FIG. 23 conceptually illustrates the use of a machine-trained network to generate multiple 2-D cross sections for each design layout shape representing an interconnect wire segment for different process conditions, and then connect the cross sections for each shape to generate the 3-D shapes.

FIG. 24 conceptually illustrates the use of a neural network to directly generate 3-D predicted manufactured shapes.

FIG. 25 conceptually illustrates the use of a neural network to produce an output image of predicted manufactured 2-D planar shapes as well as cross sections for an input image and set of input taper angles.

FIG. 26 conceptually illustrates a novel process of some embodiments to compute capacitance coefficients for later use during extraction.

FIG. 27 conceptually illustrates another novel approach to compute capacitance coefficients for later use during extraction.

FIG. 28 conceptually illustrates another novel approach of some embodiments to compute parasitics for a wire structure.

FIGS. 29 and 30 each conceptually illustrate a design layout with four components and the predicted manufactured shape, with taper angles, for one of these components.

FIG. 31 conceptually illustrates an example process for designing and manufacturing an IC.

FIG. 32 conceptually illustrates a computer system with which some embodiments of the invention are implemented.

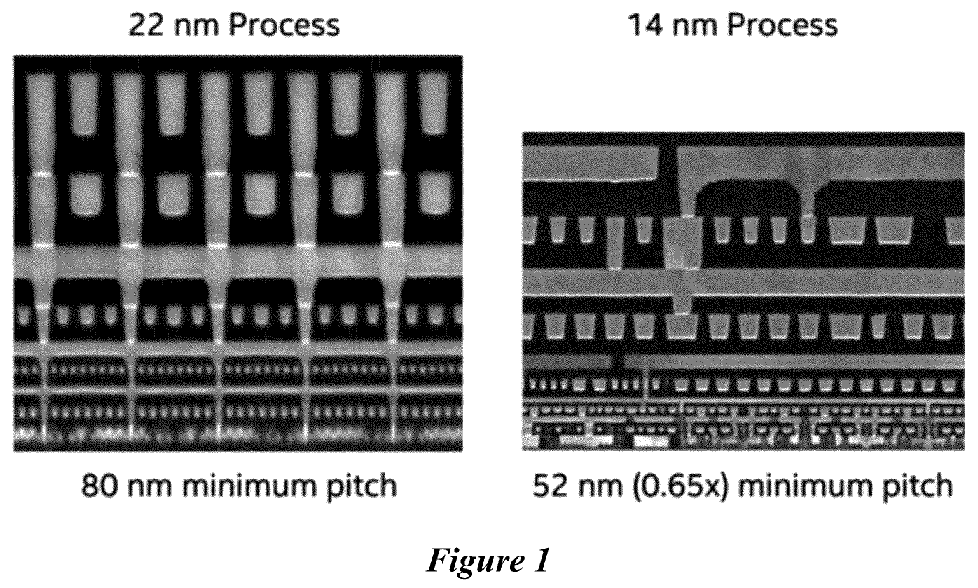

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method (performed, e.g., by a layout verification tool) that computes parasitic parameters for a design layout that defines a design for a region of an integrated circuit (IC). In some embodiments, the method identifies a set of conductive circuit components (e.g., interconnect wires, z-axis connections such as vias or contacts) in a layer of a design layout. These conductive circuit components traverse within a plane defined for the layer (e.g., an x-y plane) and have a thickness orthogonal to that plane (e.g., in the z-axis direction). The method computes, for each of the components, a set of one or more predicted manufactured shapes that have tapered cross sections in the direction orthogonal to the plane (e.g., trapezoidal cross sections rather than rectangular as would be the case for non-tapered cross sections). The method uses these predicted manufactured shapes to compute parasitic values that express parasitic effects of the conductive circuit components (e.g., parasitic coupling capacitance values).

In some embodiments, the design layout is a design layout for a wire structure that is to be manufactured on a substrate, such as a silicon wafer. In some such embodiments, the wire structure includes several interconnect wire segments (e.g., a type of conductive circuit components) that have rectilinear shapes (i.e., the shapes are produced by using straight line segments). However, at least some of the predicted manufactured shapes for the interconnect wire segments have curvilinear shapes (i.e., include at least one curved line segment), owing to the tendency of actual manufacturing processes to produce wire segments with curvilinear features. In some embodiments, the design layout itself may include curvilinear shapes (e.g., entirely curvilinear shapes, or a combination of shapes with curvilinear and rectilinear edges).

The method, in some embodiments, initially uses the two-dimensional (2-D) design layout of the layer to generate a 2-D predicted manufactured shape for each conductive circuit component (or for the design layout region as a whole), then uses information about the component thickness and the taper angle to generate a three-dimensional (3-D) predicted manufactured shape for each conductive circuit component. These 3-D predicted manufactured shapes can then be used to accurately compute parasitic parameters for the components of the layout. Using the taper angles so that the 3-D predicted manufactured shapes more closely resemble the components as they will actually be manufactured on a substrate (as compared to the sides of the 3-D shapes being orthogonal to the plane of the 2-D shapes) results in more accurate parasitic parameter calculations.

The taper angle, in some embodiments, is defined by a manufacturing process technology file that specifies various aspects of the manufacturing process, including the expected taper angle that will result from the manufacturing of the conductive components on the substrate. The taper angle is the result of how light penetrates through the mask(s) during the manufacturing process, forming slightly tapered sides of the conductive circuit components rather than perfectly rectangular sides.

A mask is an opaque plate with transparent areas that let light in through a defined pattern. The transparent areas of a mask are determined by a corresponding mask layout that includes a set of one or more mask images and that maps out the transparent areas of the mask. Mask images define the mask layout in the geometric domain and show the pattern of the transparent areas. In some embodiments, the mask images are rasterized into mask pixel images, which define the mask layout in the pixel domain.

Masks are used to fabricate one or more layers of an IC. In some embodiments, one IC layer corresponds to a set of one or more masks of a mask layout such that the IC layer is fabricated using the set of masks. In some of these embodiments, one mask fabricates at least some of two or more layers. Examples of IC layers include metal layers, via layers, wiring layers, substrate layers, and interconnect layers. Mask simulation is the generation of a mask image (conjunctively or alternatively, a mask pixel image) in order to simulate what its corresponding mask would look like when it is actually manufactured. Mask optimization is the modifying of one or more mask images of a mask layout to get a resulting mask layout that produces an optimized mask. In some embodiments, mask optimization is performed using wafer simulation.

A substrate is a type of base board used to package a bare IC chip. A wafer is an example of a substrate, and is a thin slice of semiconductor (e.g., silicon) material used for the fabrication of ICs. Light is shone through a mask (i.e., through the mask's transparent areas) onto a wafer to fabricate a layer (e.g., a wiring layer) of an IC on the wafer. The wiring layers, in some embodiments, include numerous conductive components (e.g., interconnect segments). In some embodiments, light is shone through multiple masks, one at a time, to fabricate a layer of an IC. Wafer simulation is the generation of one or more wafer images (e.g., wafer pixel images, wafer contour images) using one or more mask pixel images rasterized from mask images of a mask layout to simulate what a wafer would look like based on that mask layout.

Before masks and wafers are generated based on a design layout, some embodiments first verify the design layout. In some of these embodiments, extraction, such as parasitic extraction, is performed during design layout verification. Parasitic extraction calculates the parasitic effects that the different conductive IC components in a design layout have on each other. These conductive IC components can include wires as well as z-axis connections (e.g., vias and contacts). Types of parasitics include parasitic capacitance, resistance, and inductance. Accurate parasitic extraction of IC components of a design layout is necessary, as it allows for a more accurate design layout for the corresponding IC that will be manufactured from it.

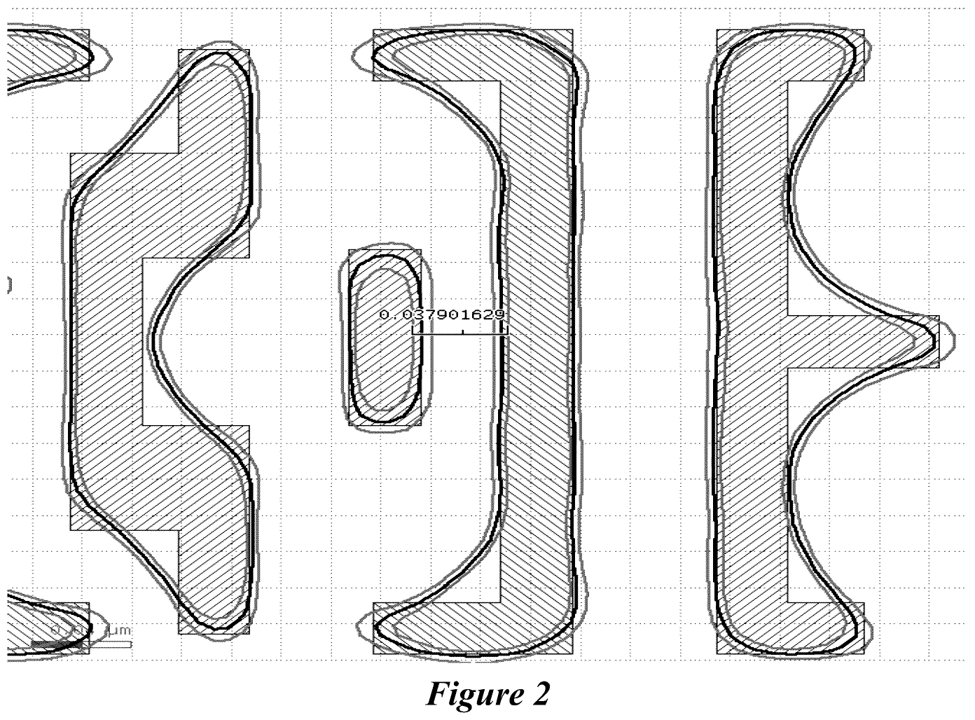

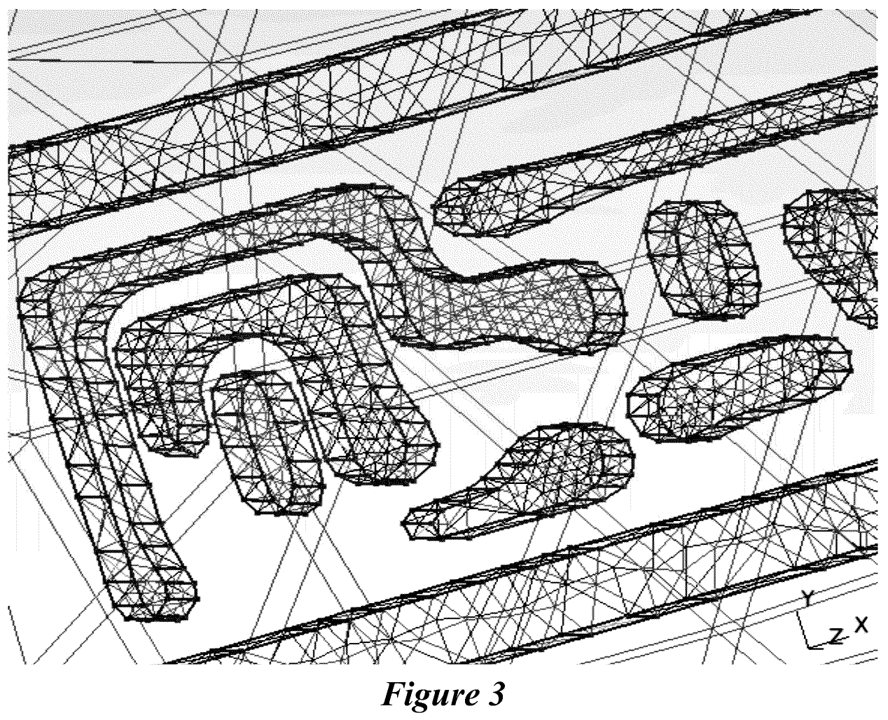

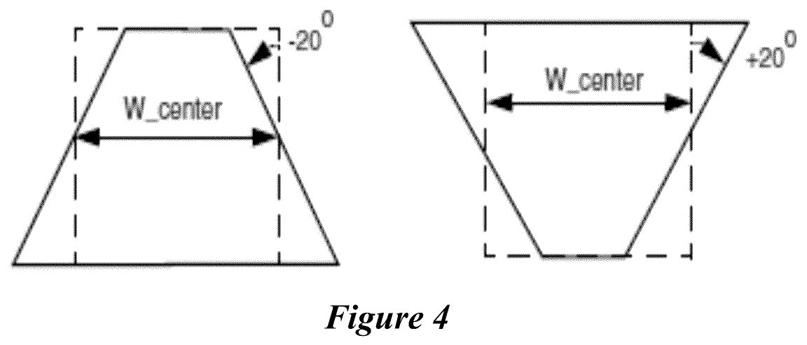

In some embodiments, 2-D plane shapes (such as the inner, middle, and outer curvilinear 2-D plane shapes in FIG. 2) of IC components are extruded in the Z dimension in order to create a set of predicted manufactured 3-D structures of the IC components, which are then meshed and input to a detailed solver (e.g., an EM solver, a machine-trained network) in order to extract accurate capacitance values for the IC components. FIG. 3 illustrates an example of such 3-D structures for interconnect extraction with an EM solver. To achieve high accuracy, it is important that the extrusion process be aware of the tapered (e.g., trapezoidal) cross sections of IC components (such as interconnect wire segments). As such, the extrusion process of some embodiments extrudes these cross sections in the Z dimension, no longer assuming a rectangular cross section. These extruded cross sections can be trapezoidal, such as shown in FIG. 4.

FIG. 4 illustrates an example of a trapezoidal cross section of an IC component with a 20-degree taper angle after manufacturing. In different embodiments, the taper angle may be negative or positive. FIG. 4 illustrates examples of trapezoidal cross sections of IC components with negative (left) and positive (right) taper angle values. In some embodiments, different process-condition-specific angles are used in the trapezoidal profile when extruding in the Z dimension at different sets of one or more process conditions. For example, for a small-geometry process, the trapezoidal cross-section angle in some embodiments is typically some amount, such as 5 degrees at the nominal process condition set. However, in some embodiments, a different average angle is found (e.g., 6 degrees) at the process extreme that produces the outer 2-D plane shape (such as the outer 2-D plane shape in FIG. 2), and a different number again (e.g., 4 degrees) at the inner process extreme condition set.

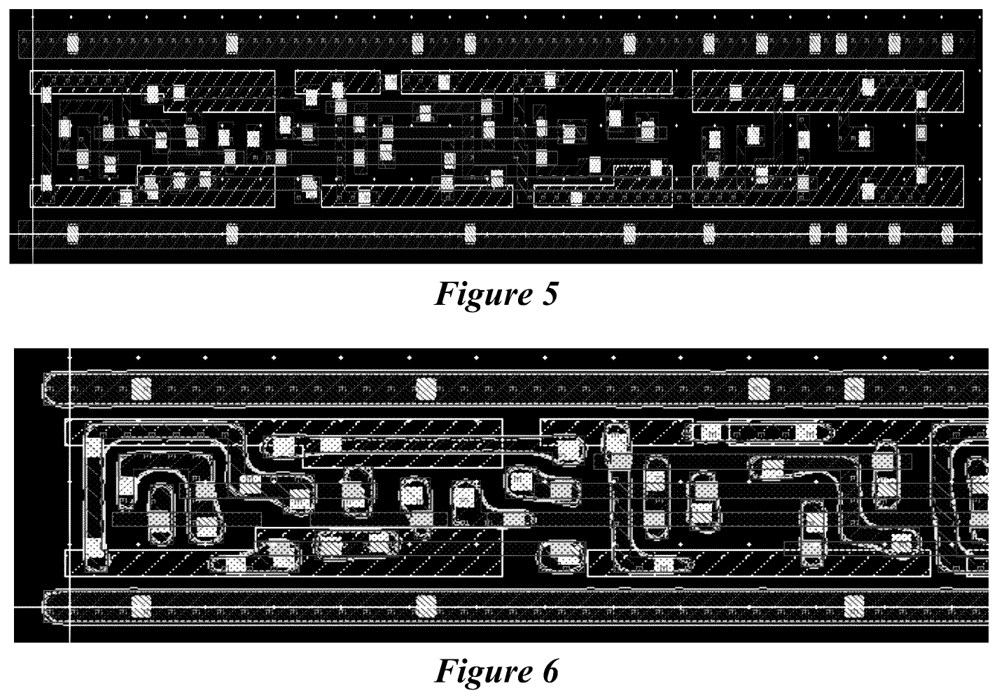

FIG. 5 illustrates an example of a scan flop standard cell library element of some embodiments. The figure shows a partial layout for a scan flop from a representative small-geometry (e.g., 3 m) process standard cell library. FIG. 6 illustrates an example of a scan flop standard cell library element of some embodiments with curvilinear shapes added to show how the drawn rectilinear polygons of the IC components are actually manufactured at various sets of process conditions in some embodiments. In some embodiments, these curvilinear 2-D plane shapes of IC components of designs as shown in FIG. 6 are extruded in the Z dimension to create 3-D predicted manufactured shapes of the IC components with trapezoidal cross sections. The 3-D predicted manufactured shapes are then meshed (e.g., with a triangular or quadrilateral mesh) to create surface panels, which can be used in performing parasitic extraction.

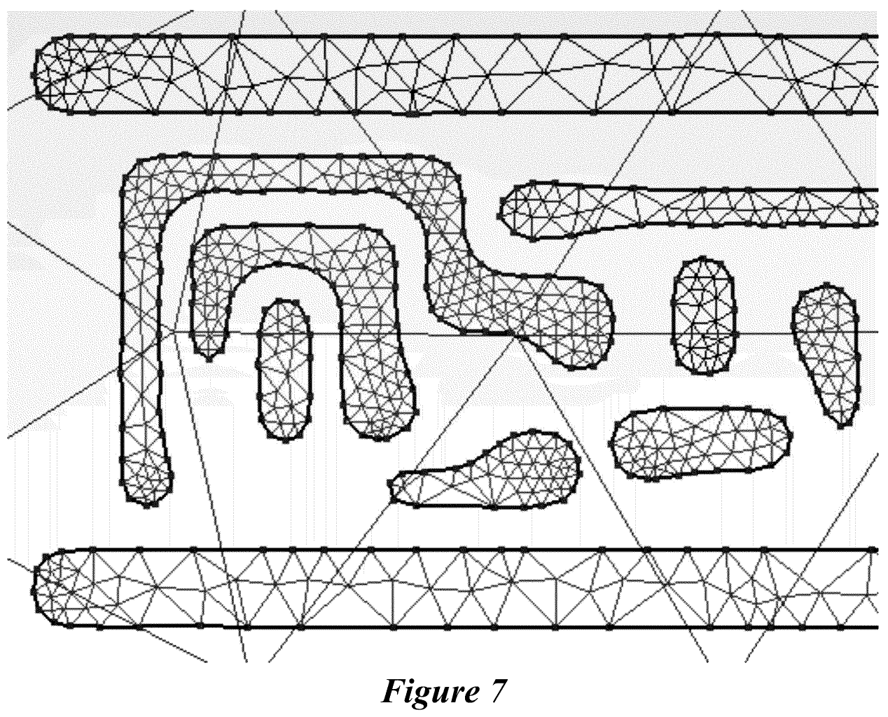

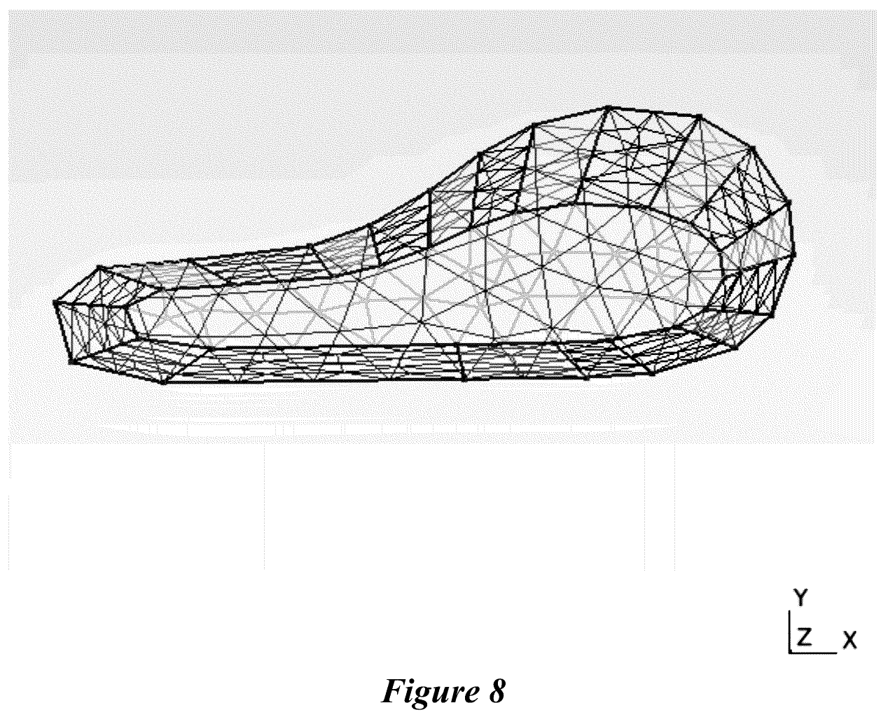

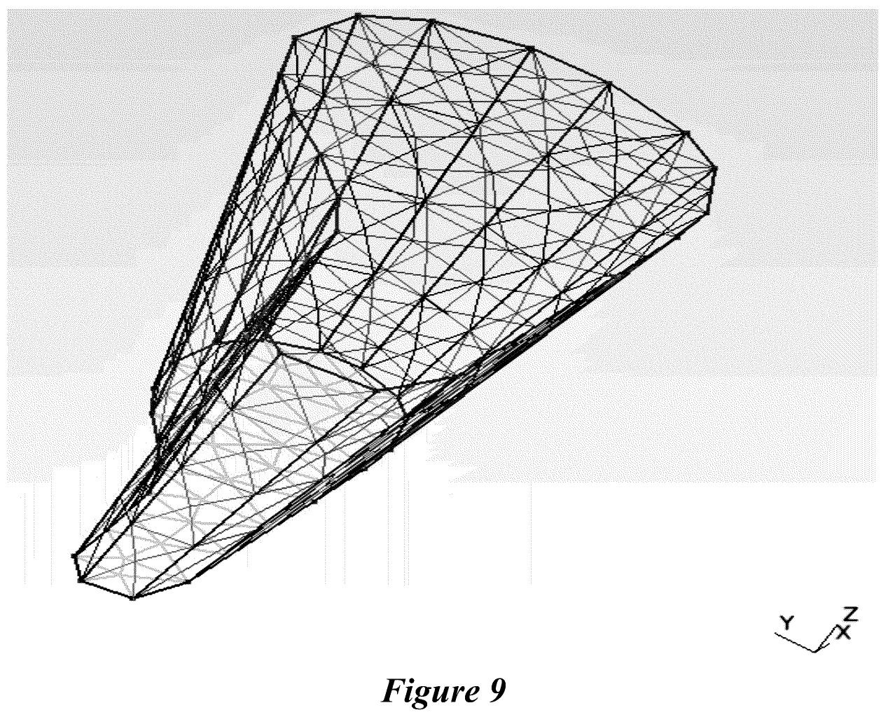

FIG. 7 illustrates an example of a scan flop design 3-D model surface mesh for the top surface of IC components. The figure shows a triangular mesh produced for the top surface of some of the 3-D predicted manufactured shapes created for the scan flop. FIG. 8 illustrates an example of a 3-D model surface mesh for a single conductor showing all surfaces from a plan view. The trapezoidal cross sections computed for the interconnect structure shows all surfaces of one of the pieces of interconnect, looking down from above the IC surface. In this example, for a process with a significant trapezoidal taper angle, the top and bottom surfaces are clearly different sizes. FIG. 9 illustrates an example of a 3-D model surface mesh for a single conductor showing all surfaces from an oblique view. In some embodiments, different taper angles are used at different process conditions and have significant effects on the capacitances computed by the 3-D solver.

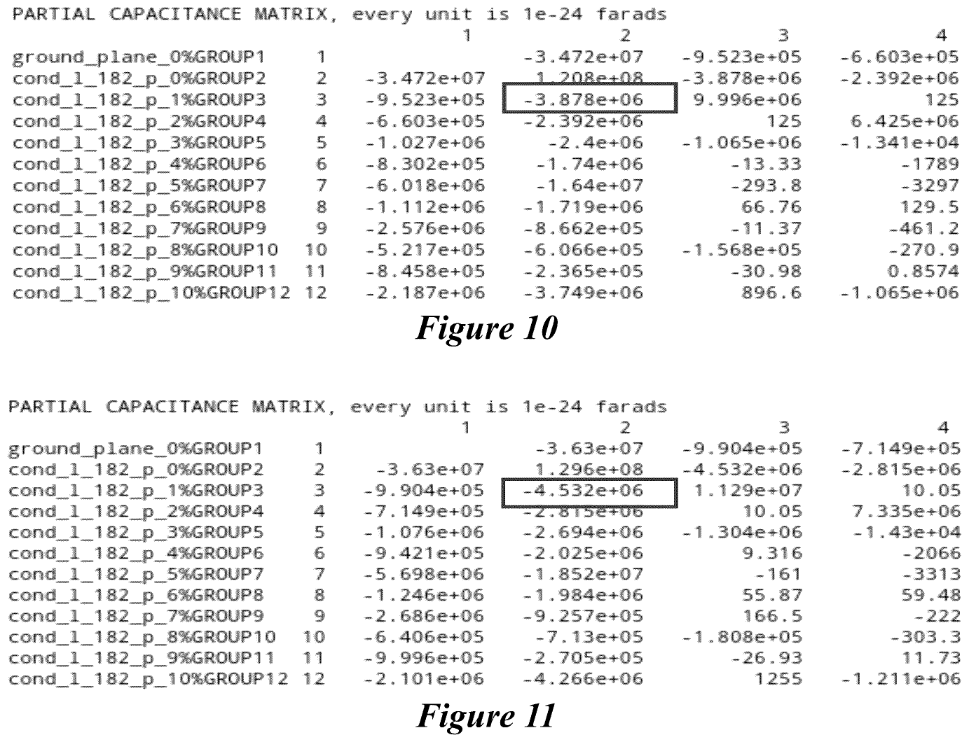

FIG. 10 illustrates a capacitance matrix computed for a particular IC component with a 6-degree taper tangle as a process variation. Some computed capacitances extracted by an EM solver for a set of 2-D plane shapes extruded with a 6-degree taper angle are shown in the table. FIG. 11 illustrates a capacitance matrix for the same particular IC component with a 4-degree taper angle as a process variation. The figure shows corresponding capacitances for the particular IC component but using a 4-degree taper angle. For both FIGS. 10 and 11, a coupling capacitance (boxed) between conductor 2 and conductor 3 is shown to vary significantly, from 3.878 units in one case to 4.532 units in the other, a difference of almost 17 percent. This difference is due to the different taper angles used.

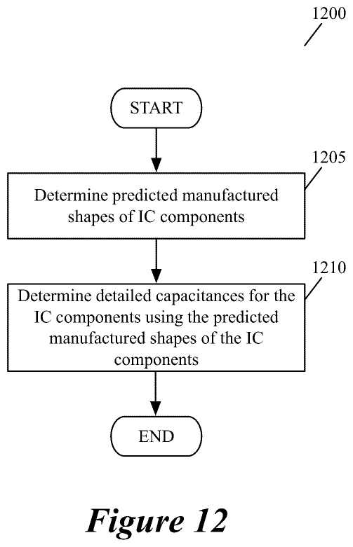

FIG. 12 conceptually illustrates a process 1200 of some embodiments for generating detailed capacitances. The process 1200 is a high-level process that determines the capacitance of IC components using their predicted manufactured 3-D shapes with tapered cross sections determined according to process parameters. As shown, the process 1200 begins by determining (at 1205) predicted manufactured shapes of IC components. In some embodiments, these shapes are determined from the IC components drawn by a circuit designer (typically rectilinear shapes, but also partially or fully curvilinear shapes in some embodiments). In some embodiments, the predicted manufactured shapes are determined using a trained neural network. In some embodiments, 2-D predicted manufactured shapes are generated, which are then post-processed to produce 3-D predicted manufactured shapes with tapered cross sections in a third dimension. Next, the process determines (at 1210) detailed capacitances for the IC components using the predicted manufactured shapes. After 1210, the process ends.

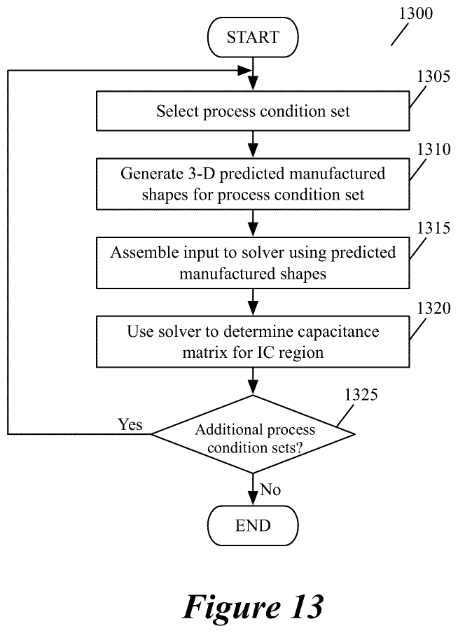

FIG. 13 conceptually illustrates a process 1300 of some embodiments for generating capacitance values using a solver (e.g., an EM field solver or a different type of capacitance solver). The detailed process by which this is achieved involves generating the necessary inputs to and invocation of an EM solver in some embodiments. In some embodiments, the process 1300 is performed by a layout verification tool that computes capacitances for predicted manufactured shapes in a region of an IC (e.g., an interconnect (metal) layer of the IC or a region of such an IC layer).

As shown, the process 1300 begins by selecting (at 1305) a process condition set. In some embodiments, the process 1300 generates predicted manufactured shapes for multiple different process condition sets. For instance, as noted above, some embodiments use maximum, minimum, and nominal (average) process condition sets and compute capacitance values for these various different conditions. The process condition sets represent different manufacturing process conditions that can occur when fabricating an IC. For instance, the depth of focus and dose margin during photolithography (fabrication of the wafer using a mask or set of masks) can affect the size and/or shape of the interconnect wires on the manufactured IC. In some embodiments, the nominal process condition set represents an average set of conditions, while the maximum and minimum process condition sets represent a certain number of standard deviations from the average, a percentage of the most extreme variations, or the actual most extreme variations.

For the selected process condition set, the process 1300 generates (at 1310) 3-D predicted manufactured shapes for the interconnect segments in the region of the IC currently being analyzed. Different embodiments may use different techniques to generate these predicted manufactured shapes, as described further below. For instance, some embodiments use a machine-trained network to generate a 2-D cross section for each interconnect segment in the x-y plane (i.e., the plane defined by the interconnect layer being analyzed). For a given 2-D cross section shape, the taper angle is determined along the contour of the shape (e.g., either a constant taper angle or a taper angle that varies for each pixel or point along the contour), and this taper angle is used to determine another 2-D cross section shape. One of these shapes is the “bottom” of the 3-D shape and the other is the “top”, and the two shapes can be connected to form the 3-D shapes.

Other embodiments directly generate the 3-D shapes from the design layout (e.g., using a machine-trained network). Still other embodiments generate (e.g., using a machine-trained network) multiple different 2-D cross sections parallel to the x-y plane defined for the layer (e.g., the top and bottom cross sections described above, or more than two such cross sections), then connect those cross sections to form the sidewall panels of the 3-D shape. Yet other embodiments may use different techniques to generate the 3-D predicted manufactured shapes.

The process 1300 then assembles (at 1315) input to the parasitics solver using the 3-D predicted manufactured shapes. For instance, certain capacitance solvers require mesh inputs in a specific form defining each of the shapes, in which case the layout verification tool assembles these mesh inputs. Some embodiments also define additional process technology related information, such as the relative permittivity of the conductors and insulator material. Furthermore, ground planes are inserted where appropriate.

In some embodiments, the 3-D predicted shape is defined by a set of vertices in an upper polygon (cross section) and a set of vertices in a lower polygon (cross section). In some embodiments, the number of vertices in the upper polygon corresponds exactly to that of the lower polygon, and the sidewall panels are trapezoidal. In other embodiments, the number of vertices in the upper polygon differs from that of the lower polygon and so triangular sidewall panels are generated. For triangular panels, if the upper polygon has more vertices than the lower polygon, then multiple vertices of the upper polygon in some embodiments are connected to a single vertex of the lower polygon, and vice versa. The sidewall panels joining the upper and lower polygons define a 3-D structure, for which the process a 2-D surface. In some embodiments, an unstructured grid is superimposed upon the surface panels of the 3-D structure. A representation of such an unstructured grid, superimposed as a 2-D mesh on a collection of 3-D curvilinear structures is shown in FIG. 3.

The process 1300 then uses (at 1320) the parasitics solver (e.g., an EM field solver, another type of field solver, a machine-trained network, etc.) to determine a capacitance matrix for the IC region. Examples of such capacitance matrices are shown in FIGS. 10-11. The process 1300 then determines (at 1325) whether all process condition sets have been analyzed. If the process 1300 determines that all process condition sets have been analyzed, the process ends. Otherwise, the process 1300 returns to 1305 to analyze the next process condition set and repeat operations 1310-1320 to generate a capacitance matrix for that process condition set.

In some embodiments, even for any one process condition set, the taper angle may not be constant across all vertices of the IC component shapes. For example, in some embodiments, larger or smaller taper angles are used for vertices of a component shape that are further away from the corresponding nominal process condition vertices. The further the vertex at a process extreme is from the corresponding vertex of the nominal condition, the more (or less) its taper angle varies from the typical taper angle for that process condition set. In this case, the lower polygon will be a slightly distorted version of the upper polygon (or vice versa), rather than just a scaled-down version.

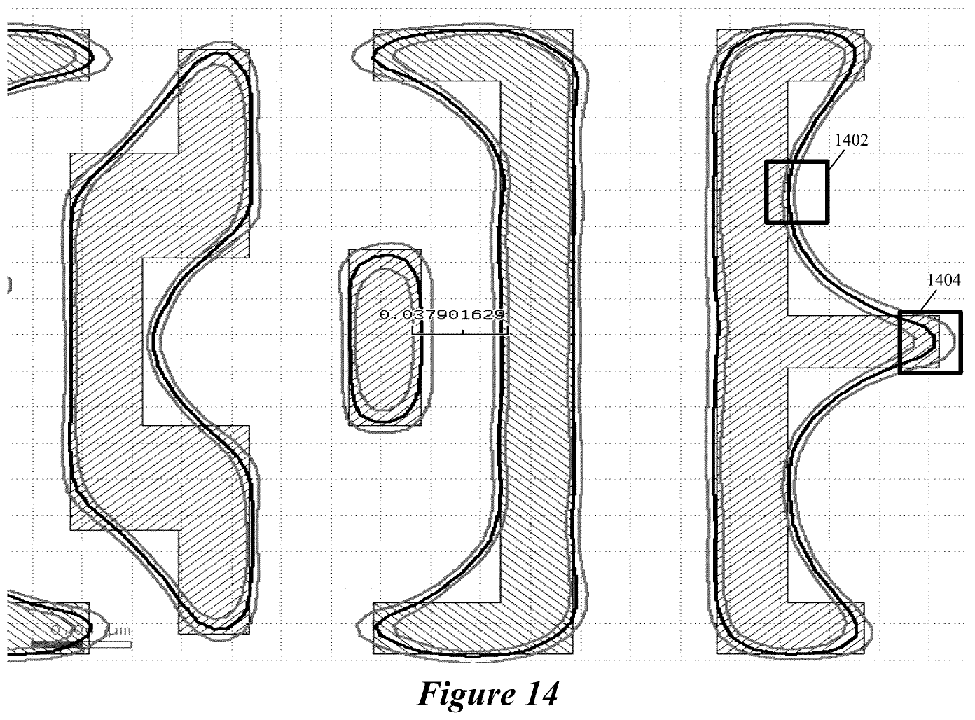

FIG. 14 illustrates regions in which taper angles vary significantly due to greater or less change from the nominal (middle) 2-D plane shape of IC components to the maximum and minimum 2-D plane shapes of these IC components. The figure shows two boxed regions 1402 and 1404, in which the inner and outer 2-D plane shapes of IC components are very close to the nominal 2-D plane shape of the IC components in some regions (as shown in upper boxed region 1402) and quite far from the nominal 2-D plane shape of the IC components in other regions (as shown in lower boxed region 1404). Here, the middle 2-D plane shape computed for the IC components corresponds to nominal process conditions, the inner 2-D plane shape computed for the IC components corresponds to one process extreme, and the outer 2-D plane shape computed for the IC components corresponds to another process extreme. In some embodiments, the taper angles for the polygon vertices within region 1402 are fairly closely in agreement with each other, while those corresponding to the polygon vertices within region 1404 differ from each other more substantially. In some embodiments, the taper angle for the nominal process condition 2-D plane shape is constant for all vertices.

In some embodiments, capacitances computed in the manner described herein are used as ground truth data for training a second neural network tasked with predicting capacitance values given the predicted manufactured shapes of interconnect structures as input. Examples of training and using such a second neural network are disclosed in U.S. patent application Ser. No. 17/871,893, now published as U.S. Patent Publication 2023/0027655, which is incorporated herein by reference.

In that approach, a variety of 2-D design shapes are generated, representative of designer-drawn layout polygons to represent the IC components in a design layout. These are then processed by a first neural network (e.g., as described in U.S. Patent Publications 2022/0128899 and 2023/0168660, which are incorporated herein by reference) to produce curvilinear 2-D plane shapes representative of the curvilinear silicon wafer shapes of the IC components that would be manufactured from the design layout. Those shapes are then extruded to a 3-D space using the methods described above (including tapered (e.g., trapezoidal) cross sections), and the resulting 3-D structures are meshed and provided as input to the EM solver to produce the capacitance values. Rasterized versions of the design layout including the 2-D design shapes of the IC components are used as training data input X, along with the EM-solver-predicted capacitance values as the training data outputs Y. The (X,Y) pairs are used to train the second neural network to produce capacitance values that correspond to the 2-D design shapes of the design layout's IC components. Hence, the capacitance extraction neural network utility is enhanced to produce even more accurate capacitance values which reflect the tapered cross-sectional nature of interconnect manufacturing.

The above description relates to several embodiments for determining predicted the as-manufactured shapes of IC components by accounting for both (i) curvilinear 2-D planar shapes and (ii) tapered cross-sections in a third dimension. Several more embodiments for determining these predicted shapes will now be described.

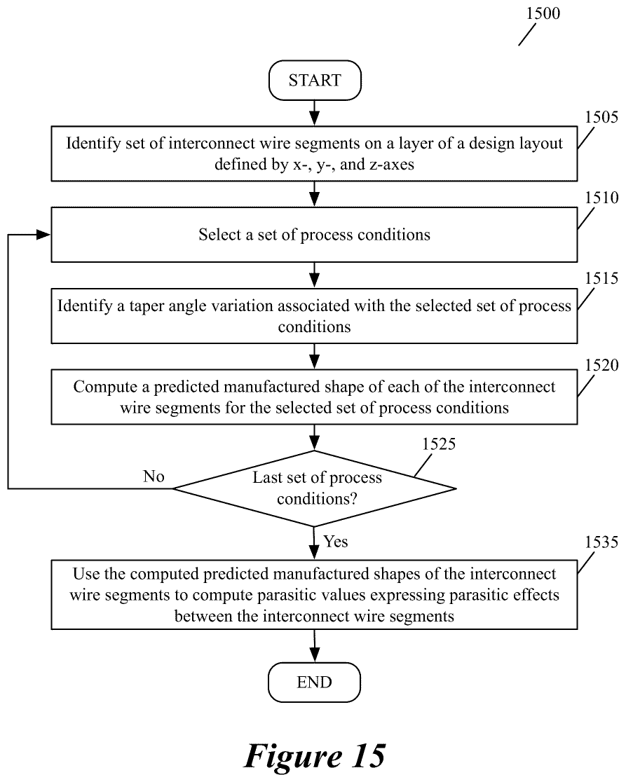

FIG. 15 conceptually illustrates a process 1500 of some embodiments for performing parasitic extraction. Different parasitic effects (e.g., capacitance, resistance, inductance, etc.) can impact circuit delay, energy consumption, and power distribution. These parasitic effects can also introduce noise sources and other effects that impact reliability of a manufactured circuit. To evaluate the effect of interconnect parasitic effects on circuit performance, they need to be accurately modeled by computing parasitic values. In order to most accurately compute the parasitic values, the circuit components should be modeled as close as possible to the shapes that will actually be manufactured.

This process 1500 is performed in some embodiments for a set of at least two interconnect wire segments on a layer of a design layout for a wire structure. In some embodiments, the wire structure is to be manufactured on a substrate based on the design layout. In some such embodiments, the wire structure includes multiple interconnect wire segments that have a rectilinear shape (i.e., the interconnect wire segments are drawn using straight line segments). The design layout is initially received, in some embodiments, through a user interface (UI) from a user that created the design layout for the wire structure.

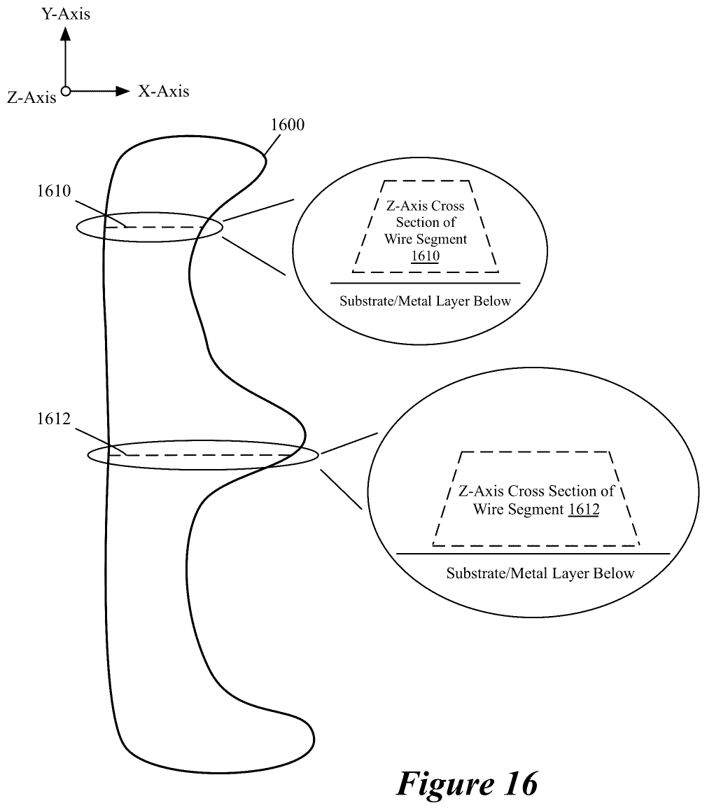

The process 1500 begins by identifying (at 1505) the set of (at least two) interconnect wire segments on the layer of the design layout defined by x-, y-, and z-axes. In some embodiments, the interconnect wire segments can be viewed as traversing along an x-y plane and having a thickness in a z-axis (orthogonal to the x-y plane). If the interconnect segments are Manhattan wire segments, then each wire segment traverses the x-y plane parallel to either the x-axis or y-axis. On the other hand, if the interconnect segments are more generically rectilinear (or even curvilinear), then the interconnect segments are not restricted to traversal in any specific direction within the x-y plane. In some embodiments, the interconnect wire segments are defined in two dimensions (i.e., within the x-y plane) in the design layout, with the thickness defined as part of the process technology file specifying the manufacturing process. Examples of an interconnect wire segment are shown in FIGS. 16-18, which will be described in more detail below.

In general, parasitic values such as capacitance are computed between pairs of interconnect wire segments (in addition to self-parasitics, such as self-capacitance). Thus, when computing parasitics for a set of multiple interconnect wire segments, the parasitic values are computed between each pair of interconnect wire segments in the set. In a paper entitled “Analysis and Justification of a Simple, Practical 2 ½D Capacitance Extraction Methodology” by Cong et al., five foundations for a capacitance extraction methodology are presented. The first foundation is that “ground, and neighboring wires on the same layer have significant shielding effects. Thus, both must be considered for accurate modeling. The second foundation is that “coupling between wires in layer i+1 and wires on layer i−1 is negligible when the metal density on layer i exceeds a certain threshold.”

The third is that “during capacitance extraction for wires on layer i, layers i+/−2 can be treated as ground planes with negligible error. There is no need to look beyond layers i+/−2.” The fourth is that “coupling analysis to wires in the same layer need only consider nearest neighbors independently, with the widths of same-layer neighbor wires having negligible effects on the coupling.” Finally, the fifth and final foundation is that “the joint interaction of layers i−1 and i+1 on layer i is negligible, therefore corrections for orthogonal crossovers and crossunders can be performed incrementally.” Because neighboring wires on a single layer can affect each other, determining their parasitic effect on each other is important to most accurately model the wire structure.

Next, the process 1500 selects (at 1510) a first set of process conditions. Process condition sets (also referred to as sets of manufacturing parameters or sets of manufacturing parameter values) refer to specific factors that go into the manufacturing process and/or results of the manufacturing process. These process condition sets are used in the prediction of as-manufactured shapes of the interconnect wire segments. Manufacturing Parameters (MPs) that may be different between different process condition sets include coloring tools and parameters, OPT/ILT tools and parameters including light source and wafer process model parameters, MPC tools and parameters including mask process model parameters, fracturing tools and parameters, mask writing tools and parameters, mask processing parameters, and wafer process and parameters including light sources and wafer processing parameters. In some embodiments, manufacturing process parameters can relate to depth of focus or strength of exposure used during the wafer production process of the wire segments.

Given any input design mask reflective of a portion of a design, multiple images are produced that are reflective of the entire manufacturing process at the nominal process values, and at extreme values reflective of absolute limit values, or statistical values such as 1, 2, or 3 sigma. Each of these outputs are referred to as a ‘set’ of process conditions or as process corners, such as nominal, minimum, or maximum process condition sets or process corners.

For example, a first set of process conditions in some embodiments represents the nominal process conditions of the manufacturing parameters, which includes the average depth of focus and the average exposure strength. As another example, a second set of process conditions in some embodiments represents the maximum process conditions of the manufacturing parameters, which includes the largest depth of focus and the largest exposure strength.

In other embodiments, the second set of process conditions representing the maximum process conditions includes the smallest depth of focus and the largest exposure strength. Still, in other embodiments, the second set of process conditions representing the maximum process conditions includes the largest depth of focus and the smallest exposure strength. Any combination of process conditions can be used for each of the different sets of process conditions. There can be any number of process condition sets, and the process condition sets can be selected in any order during the process 1500.

At 1515, the process 1500 identifies an angle variation associated with the selected set of process conditions. The process 1500 of some embodiments identifies the angle variation (also referred to as a taper angle) that corresponds to the selected set of process conditions of the manufacturing process. In some embodiments, the angle variation is retrieved from a set of technology files that describes the manufacturing process parameters in detail for different process condition sets. The taper angle, as noted, is the degree to which the sides of the as-manufactured IC components are not directly orthogonal to the x-y plane, but instead are at an angle to the z-axis. Different process conditions will result in different average taper angles for the IC components during actual manufacturing, and thus these different process conditions are used to generate different manufactured shape predictions for the parasitic extraction process.

In some embodiments, the angle variation associated with the set of process conditions representing the maximum process conditions is the largest taper angle, the angle variation associated with the set of process conditions representing the nominal process conditions is the average taper angle, and the angle variation associated with the set of process conditions representing the minimum process conditions is the smallest taper angle. In other embodiments, the angle variation associated with the set of process conditions representing the maximum process conditions is the smallest taper angle, the angle variation associated with the set of process conditions representing the nominal process conditions is the average taper angle, and the angle variation associated with the set of process conditions representing the minimum process conditions is the largest taper angle. In such embodiments, the nominal angle variation remains the average taper angle. In some embodiments, the largest taper angle and smallest taper angle are not the absolute largest and/or smallest angles that might be produced, but rather are larger and/or smaller than the average by some amount (e.g., one or two standard deviations from the average taper angle). In addition, for any given set of process conditions, the taper angles may vary at any particular location along the contours of the predicted manufactured shapes.

Next, the process 1500 computes (at 1520) a predicted manufactured shape for each of the interconnect wire segments for the selected set of process conditions. The predicted manufactured shapes for the wire segments in some embodiments represent the predicted 3-D shapes of these interconnect wire segments that would actually be manufactured from the design layout. As described above by reference to FIG. 13, different embodiments use different techniques to generate these 3-D manufactured shapes. For instance, some embodiments predict a 2-D planar shape for each interconnect wire segment and use taper angle information to construct a 3-D predicted manufactured shape. Other embodiments directly predict the 3-D manufactured shape or predict multiple 2-D planar shapes at different locations along the z-axis and construct the 3-D predicted manufactured shape from these different shapes.

Yet other embodiments define each predicted manufactured shape for an interconnect wire segment using (1) a 2-D planar shape of the wire segment within the x-y plane and (2) a set of one or more cross sections within a plane orthogonal to the x-y plane (i.e., within a plane formed by the z-axis and a line in the x-y plane perpendicular to the edge of the 2-D planar shape in the x-y plane). In such embodiments, the 2-D planar shape and the cross sections define the 3-D curvilinear shape of the wire segment when the wire segment is manufactured. Curvilinear shapes, in some embodiments, can include straight (rectilinear) segments, curved segments, and/or a combination thereof.

The predicted 2-D plane shape of a wire segment is computed in some embodiments based on the rectilinear shape of the wire segment in the wire structure (i.e., the rectilinear shape drawn to represent the wire segment in the design layout) and the process condition set. The set of cross sections is computed in some embodiments based on the angle variation and the 2-D plane shape. In some such embodiments, the angle variation determines the amount of tapering of each cross section for the wire segment (resulting in trapezoidal cross sections). That is, if the predicted 2-D plane shape of the wire segment is viewed as the “top” of the predicted 3-D manufactured shape of the wire segment, then the angle variation for a process condition set defines the angle of the “sides” of the cross sections relative to the z-axis (i.e., the sides of this 3-D manufactured shape), and the “bottom” of the predicted 3-D manufactured shape has the same or similar shape as the top of the 3-D shape but either smaller or larger based on the taper angle and the thickness of the wire segment (which may be determined from the process technology file).

Some embodiments also combine (effectively superimpose) predicted 2-D plane shapes across different neighborhoods (i.e., local areas in the planar space of a layer). More specifically, some embodiments effectively anticipate and take neighborhood-induced variations into account. The 2-D plane shapes used in the resulting computations in some embodiments are statistically determined or are simply taken as the most extreme possible (the largest possible ‘outer’ 2-D plane shape of the IC component and the smallest possible ‘inner’ 2-D plane shape of the IC component).

In some embodiments, the predicted manufactured shapes of the interconnect wire segments are computed by supplying the set of interconnect wire segments (and, in certain cases, the angle variation(s)) to a machine-trained network that computes the predicted manufactured shapes of the interconnect wire segments. In various embodiments, the machine-trained network determines the 2-D planar shape, multiple 2-D planar shapes, and/or the 3-D predicted manufactured shape. In some embodiments, the machine-trained network determines the 2-D plane shapes (based on the wire segments in the design layout) and then the taper angle(s) specified by the selected process condition set is used to generate the cross sections. The machine-trained network is in some embodiments a neural network with several machine-trained neurons. In some such embodiments, the neural network accounts for variations in process technology, and the neural network uses a predetermined set of weights corresponding to each variation in the process technology. In other embodiments, the predicted manufactured shapes of the interconnect wire segments are determined using other algorithmic processes. Any suitable process may be used to compute predicted manufactured shapes for the IC components.

At 1525, the process 1500 determines whether the selected set of process conditions is the last set of process conditions. To predict the 3-D manufactured shape of each wire segment at each manufacturing process variation, a different predicted manufactured shape of each wire segment is computed for each process condition set. If the process 1500 determines that the selected process condition set is not the last process condition set (i.e., that at least one other set of process conditions has yet to be selected to compute predicted manufactured shapes for both interconnect wire segments), the process 1500 selects (at 1500) a next set of process conditions and returns to step 1515.

If the process 1500 determines that the selected set of process conditions is the last set of process conditions (i.e., that all process condition sets have been selected to compute predicted manufactured shapes for the interconnect wire segments), the process 1500 uses (at 1535) the predicted manufactured shapes of the set of interconnect wire segments to compute parasitic values expressing parasitic effects of between the interconnect wire segments (e.g., self-capacitance for each interconnect wire segment and capacitive coupling between pairs of interconnect wire segments). In some embodiments, the process of computing the predicted manufactured shapes of the interconnect wire segments results in a set of predicted manufactured shapes of each interconnect wire segment.

In some embodiments, each predicted manufactured shape in the set of predicted manufactured shapes for a given interconnect wire segment is associated with a different variation of a set of variations (i.e., a different set of process conditions) of a manufacturing process parameter. More specifically, the set of predicted manufactured shapes for an interconnect wire segment includes at least one of (1) a first predicted manufactured shape relating to a maximum variation of the manufacturing process parameter, (2) a second predicted manufactured shape relating to a minimum variation of the manufacturing process parameter, and (3) a third predicted manufactured shape relating to a nominal variation of the manufacturing process parameter in some embodiments. In such embodiments, maximum, minimum, and/or nominal process condition sets are used to predict manufactured shapes of the interconnect wire segments.

In some embodiments, the manufacturing process parameter is associated with a manufacturing process that will be used to manufacture the wire structure from the design layout. In some of these embodiments, the manufacturing process is a mask making process and the manufacturing process parameter relates to dosage used during the mask making process. Alternatively, the manufacturing process is a wafer simulation process and the particular manufacturing process parameter relates to at least one of depth of focus and strength of exposure used during the wafer production process.

The process 1500 computes the parasitic value using a field solver, such as an EM solver, in some embodiments. In some such embodiments, for each predicted 3-D manufactured shape (e.g., defined by a 2-D plane shape and a set of cross sections) of each interconnect wire segment, the process 1500 computes a set of surface panels (also referred to as a surface mesh) to define the top, bottom, and sides of the predicted 3-D manufactured shape. In some embodiments, these panels are simply computed as rectangles. In more complex embodiments, these panels are computed by applying a more complex meshing algorithm. For instance, some embodiments produce triangular or quadrilateral meshes. Ground planes are then inserted above and below the top and bottom layers. The surface panel information is then used as input and solved (independently) by a field solver (e.g., FastCAP), which produces capacitance matrices. The resulting capacitance matrices are then post-processed to produce values for self-capacitances and/or coupling capacitances.

The surface panel sets are computed in such embodiments because the field solver (e.g., FastCAP) requires these in order to compute parasitic values. Other embodiments, however, use field solvers that do not require such surface panels as input to compute parasitic values. In this case, the process 1500 does not compute the surface panel sets and provides the predicted manufactured shapes (i.e., the 2-D plane shapes and the sides of the shapes) to the field solver to compute the parasitic value. In some of these embodiments, the process 1500 translates the predicted manufactured shapes of the interconnect wire segments into a format understood by the field solver (e.g., a set of vertices of the shapes in a 3-D space) before supplying the translated predicted manufactured shapes of the interconnect wire segments to the field solver.

In some embodiments, a parasitic value indicates a parasitic parameter associated with one or more wire structures. For example, the parasitic parameter can be one of unwanted parasitic resistance, parasitic inductance, or parasitic self-capacitance for a wire structure, or one of mutual inductance or coupling capacitance between a pair of wire structures. By computing the parasitic value, for example, the effect that one of the interconnect wire segments would have on another of the interconnect wire segments when the wire structure is actually manufactured is predicted. Using this information, the designer of the design layout can examine the parasitic effects of the wire segments and make any changes to the design layout to change or compensate for the parasitic effects. After using the predicted manufactured shapes to compute the parasitic value, the process 1500 ends.

FIGS. 16-18 illustrate example predicted 2-D shapes, cross sections, and 3-D manufactured shapes (formed by the 2-D shapes and cross-sections) computed for an interconnect wire segment. FIG. 16 illustrates an example of a predicted manufactured 2-D shape 1600 for an interconnect wire segment. This figure shows a 3-D space using x-, y-, and z-axes, with the 2-D shape 1600 of the wire segment being a curvilinear shape in the x-y plane. The figure also illustrates a set of cross sections 1610 and 1612 computed for the wire segment, which shows the tapered shape of the wire segment in the z direction.

These cross sections are in the x-z plane, but in general the tapered cross sections are in the plane formed by the z-axis and a direction in the x-y plane perpendicular to the traversal direction of the interconnect wire segment within the x-y plane. In this case, that traversal direction is along the y-axis, and thus the direction in the x-y plane that forms the plane for the cross-section with the z-axis is the x-axis. If the interconnect wire segment was rotated 45° (i.e., in the direction of a line with a slope of 1 in the x-y plane), then the cross-sections would be in planes formed by the z-axis and a line with a slope of −1 in the x-y plane). It should also be noted that with the tapered sides of the 3-D manufactured shapes, any cross section of the 3-D manufactured shape aligned with the z-axis will be trapezoidal in nature; the cross-sections referred to herein are the isosceles trapezoidal cross-sections. However, if the taper angles vary based on location along the 2-D planar shape, even these trapezoidal cross-sections may not be isosceles trapezoids (because the taper angle on one side of the shape may differ from the taper angle on the other side).

The 2-D plane shape 1600 as well as the cross sections 1610 and 1612 for an interconnect wire segment are produced in some embodiments from a rectilinear shape that represents the wire segment in a design layout. In some embodiments, the 2-D plane shape and/or the cross sections 1610 and 1612 are produced for a specific set of process conditions. However, other sets of process conditions produce other 2-D plane shapes and/or cross sections for the wire segment in some embodiments.

For example, if the cross sections 1610 and 1612 are produced for the nominal process conditions of the manufacturing process parameters, then cross sections produced instead for the maximum process conditions or the minimum process conditions of the manufacturing process parameters may differ from the cross sections 1610 and 1612 (e.g., due to different 2-D plane shapes and/or different taper angles). That is, while this example shows only one 2-D plane shape and cross sections as representative of semiconductor manufacturing process conditions, a more comprehensive set of predicted manufacturing shapes can be based on additional process parameters representing the different extremes in mask and wafer manufacturing.

The cross sections 1610 and 1612 (as well as the cross sections at any other point along the y axis) that are defined for the wire segment in FIG. 16 represent the tapered width of the wire segment 1600 that would occur when manufacturing the wire segment 1600 to a thickness specified by the technology process file for the wire segments. The cross sections 1610 and 1612 represent the predicted tapering for a particular manufacturing process variation (i.e., for a particular set of process conditions). In this example, the cross sections 1610 and 1612 shown are trapezoids that have been generated using a fixed taper angle as well as the particular predicted 2-D plane shape (e.g., a nominal, maximum, or minimum 2-D plane shape) for the interconnect wire segment based on the particular manufacturing process variation.

In this example, only the predicted shape 1600 and cross sections 1610 and 1612 for the wire segment are shown. Some embodiments provide (e.g., to a user) additional visualizations that superimpose the predicted shape and/or the cross sections on the rectilinear shaped design drawn for the wire segment 1600 (similar to the 2-D plane shapes superimposed on the cross-hatched designs shown in FIGS. 2 and 14). This allows a user (e.g., a circuit designer) to view the predicted shape and cross sections in the full context of the design. The visualization representations of the wire segment and the cross sections are intended to accurately represent the design as it will be manufactured, by taking OPC/ILT mask correction, lithography effects, and manufacturing angle variations into account at small process geometries.

The width of the cross sections 1610 and 1612 are different due to the varying width (in the x-axis) of the predicted wire segment shape 1600. However, because all of the shown cross sections 1610 and 1612 were generated for the same set of process conditions with a fixed taper angle, the same taper angle is used. As such, the tapering of each cross section 1610-1612 is the same, and each cross section is a trapezoid with the same angle of its sides relative to the parallel top and bottom. In some embodiments, these trapezoids have the same height (i.e., distance between the top and bottom owing to a uniform (or at least very close to uniform as manufactured) thickness of the wire segment.

Rather than using a single fixed taper angle per process condition set (i.e., a single taper angle for each set of for one or more manufacturing process parameters), some embodiments use taper angles that vary based on the location in the IC design. For instance, some embodiments can identify a taper angle for each (x,y) point along each planar shape (or at each pixel if using a pixel representation of the predicted shapes). In some embodiments, these taper angles are a function of dose margin (exposure) and depth of focus measures at each point. Specifically, some embodiments can identify this information from an inverse lithography technology (ILT) program that is used to optimize masks layouts used to fabricate the IC. Given different process conditions (which specify different dose margin and depth of focus), in some embodiments the ILT program can provide the dose margin and depth of focus measures for each point, which in turn can be used to predict the taper angles. As such, the cross sections for a predicted manufactured shape can include cross sections with different angle variations and different sizes, rather than just different widths as shown in FIG. 16.

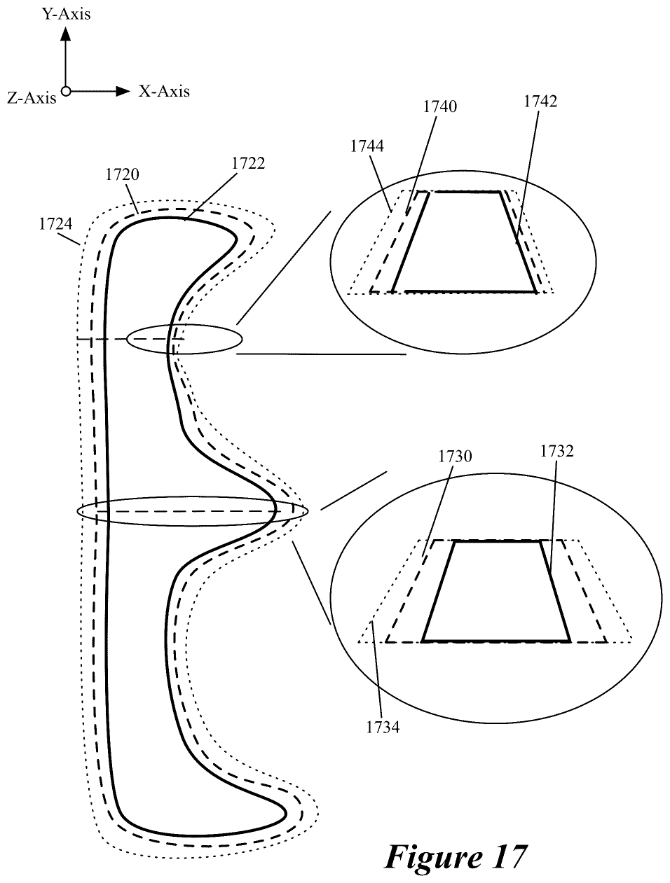

FIG. 17 illustrates three predicted 2-D plane shapes 1720-1724 of the same wire segment that are computed to represent the shape of the wire segment in the x-y plane at different manufacturing process variations. In this example, a nominal 2-D plane shape 1720 of the wire segment is illustrated using a long-dashed line, a minimum 2-D plane shape 1722 of the wire segment is illustrated using a solid line, and a maximum 2-D plane shape 1724 of the wire segment is illustrated using a short-dashed line.

This figure also illustrates different cross sections 1730-1734 and 1740-1744 corresponding to the different 2-D plane shapes 1720-1724 of the wire segment, at two different locations along the 2-D plane shapes. At a first location at which the distances between the three 2-D plane shapes 1720-1724 are the greatest, a nominal cross section 1730 is illustrated using a long-dashed line, a minimum cross section 1732 is illustrated using a solid line, and a maximum cross section 1734 is illustrated using a short-dashed line. All of the cross sections 1730-1734 are from the same point on the y-axis (along the same point in the 2-D shapes 1720-1724), and are illustrated to show (i) the varying predicted width of the wire segment and (ii) the varying taper angles of the cross sections at the different manufacturing variations.

As shown, the minimum cross section 1732 is the smallest cross section, and shows that the minimum process condition set produces the narrowest version of the wire segment. The nominal cross section 1730 is the middle cross section and shows that the nominal process condition set produces an average width of the wire segment. The maximum cross section 1734 is the largest cross section and shows that the maximum process condition set produces the widest version of the wire segment. In some embodiments, the different cross sections 1730-1734 also have different angles at their vertices, which can be due to (i) different taper angles being associated with the different process condition sets or (ii) different geometries having different associated taper angles. However, as shown, in some embodiments the thickness along the z-axis is the same for all three cross sections because the wire segments have the same thickness irrespective of the process condition set.

The cross sections 1740-1744 are shown at a second location at which distances between the three 2-D plane shapes 1720-1724 are smaller. At this point, the taper angles (i) vary between the two sides of the cross sections and (ii) are different than the taper angles of the cross sections 1730-1734. Especially on the right side of the cross sections 1740-1744, where the difference between the three shapes is the smallest, the taper angles of the three cross sections is very similar.

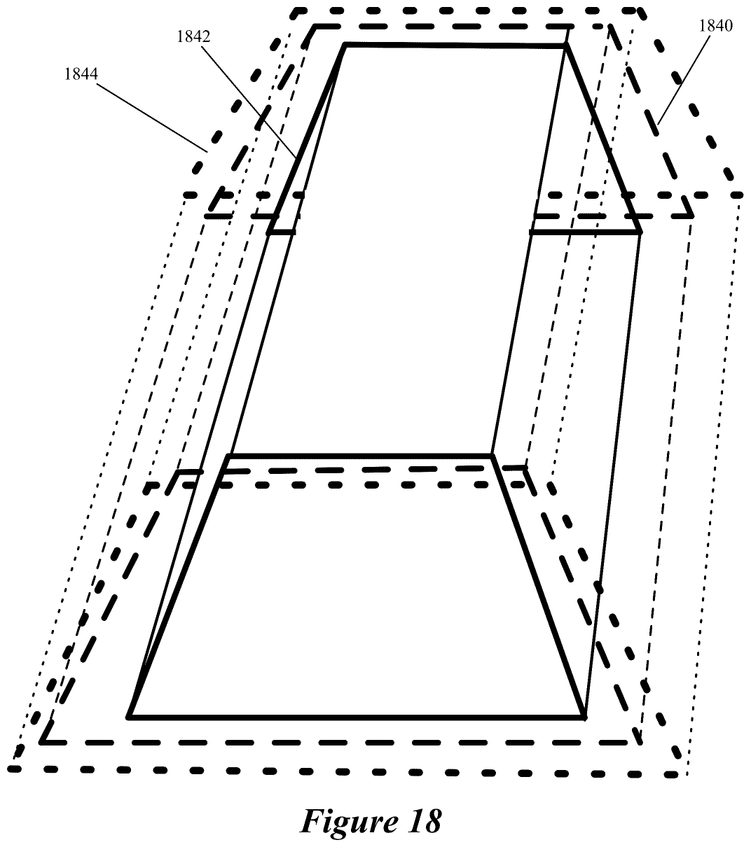

FIG. 18 illustrates three example predicted 3-D manufactured shapes 1840-1844 of a same wire segment at different manufacturing variations. For simplicity, in this figure the predicted 2-D planar shapes for the wire segment in the 2-D plane are simple rectangles (i.e., these shapes do not have any curvilinear features). As such, when accounting for the taper angle, the predicted 3-D manufactured shapes 1840-1844 are trapezoidal prisms (as the cross sections are identified as trapezoids), except that at the ends some embodiments will also have taper angles away from the direction of traversal of the wire segment. In this example, a nominal predicted 3-D manufactured shape 1840 is illustrated using a long-dashed line, a minimum predicted 3-D manufactured shape 1842 is illustrated using a solid line, and a maximum predicted 3-D manufactured shape 1844 is illustrated using a short-dashed line.

As shown, the different sets of process conditions that produce these different predicted 3-D manufactured shapes 1840-1844 of the wire segment result in different predicted widths and lengths for the wire segment. The taper angles for each of the trapezoidal prisms (i.e., the angles the sides make with the top and bottom panels) also varies between the three predicted manufactured shapes 1840-1844 based on the different process condition sets.

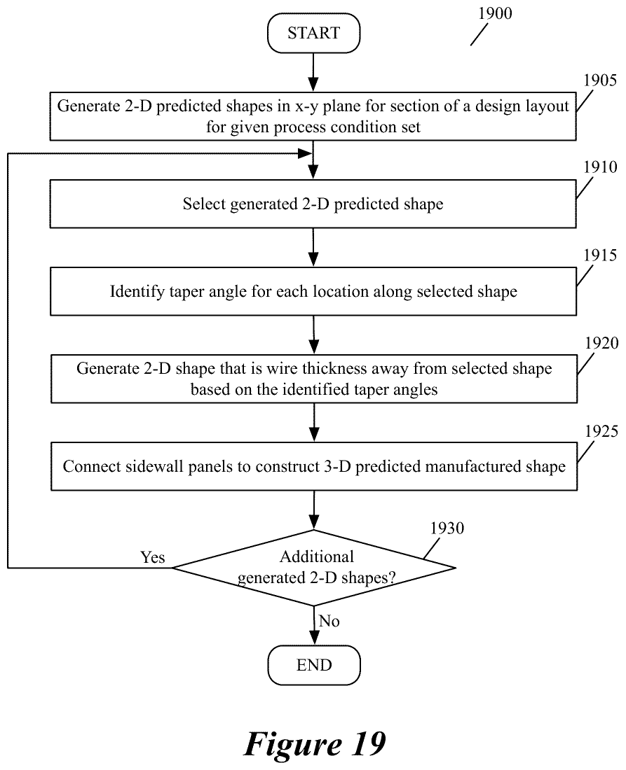

As described above, different embodiments use different techniques to generate the 3-D predicted manufactured shapes with tapered sides. FIG. 19 conceptually illustrates a process 1900 of some embodiments for generating these 3-D predicted manufactured shapes by initially generating a 2-D predicted manufactured shape for each interconnect wire segment and using taper angles to generate the 3-D predicted manufactured shapes. In some embodiments, the process 1900 is performed by a layout verification tool in order to more accurately compute parasitic values (e.g., capacitance values) for a region of an IC. In some embodiments, the process 1900 is performed at operation 1310 of the process 1300 or operation 1520 of the process 1500, both of which are described above.

As shown, the process 1900 begins by generating (at 1905) 2-D predicted shapes in the x-y plane for a section of a design layout for a given process condition set. The process 1900 is performed for each process condition set at which the parasitic values are evaluated, as noted in the description of the processes 1300 and 1500 above. The section of the design layout may be an entire layer of an IC, a portion of an IC layer (e.g., a region small enough for the 3-D shape information to be provided to a field solver, a specific portion of an IC layer that is selected by a chip designer, etc.). In some embodiments, the 2-D predicted manufactured shapes are generated based on design layout shapes representing interconnect wire segments for the design layout region. The design layout shapes may include rectilinear shapes (potentially in addition to curvilinear design layout shapes), while the predicted manufactured shapes will typically be curvilinear shapes to reflect the difficulty of actually manufacturing shapes with true straight lines (at a close enough resolution), as shown in FIG. 14.

Some embodiments use a neural network (or other machine-trained network) to generate the 2-D predicted manufactured shapes. That is, in such embodiments, the design layout region is provided as input to the network and the network outputs the predicted manufactured shapes for that region. Other embodiments may use algorithmic processes, such as application of a corner rounding algorithm (e.g., using Gaussian smoothing, etc.) to generate the predicted manufactured shapes.

The process 1900 then selects (at 1910) a generated 2-D layout shape. It should be understood that the process 1900 is a conceptual process, and that some embodiments may perform the operations 1915-1925 for numerous shapes in parallel rather than generating the 3-D predicted manufactured shapes one at a time.

The process 1900 then identifies (at 1915) a taper angle for each location along the selected shape. In some embodiments, the taper angle is fixed for all of the shapes in the design layout, in which case the taper angle may be pre-specified for the current set of process conditions (e.g., by a process technology file). In other embodiments, the taper angles vary based on the location in the IC design. For instance, some embodiments can identify a taper angle for each (x,y) point along the contour of each 2-D shape (or each discrete region of the contour). Other embodiments use a pixel representation of the predicted shapes (e.g., if the shapes are output by a neural network), and identify the taper angle for each pixel that is a boundary pixel for the 3-D shape.

In some such embodiments, the taper angles are a function of dose margin (exposure) and depth of focus measures at each point, which relate to how light is shone on the specific location during the lithography process of wafer fabrication. Specifically, some embodiments can identify this information from an inverse lithography technology (ILT) program that is used to optimize masks layouts used to fabricate the IC layers. Given different process conditions (which specify different dose margin and depth of focus), in some embodiments the ILT program can provide the dose margin and depth of focus measures for each point, which in turn can be used by the layout verification tool to predict the taper angles. As such, the cross sections for a predicted manufactured shape can include cross sections with different angle variations and different sizes.

Using the identified taper angles and the initially-generated 2-D shape, the process 1900 generates (at 1920) a 2-D shape that is a wire thickness away from the initially-generated 2-D shape. In some embodiments, this new 2-D shape is a projection of the initial 2-D shape onto a plane that is the wire thickness away from the initial 2-D shape. That is, if the initially-generated 2-D shape is thought of as the “top” panel of the 3-D predicted manufactured shape, the process then generates the “bottom” panel of that 3-D shape (or vice versa). At each location along the initial 2-D shape, the wire thickness (e.g., specified by the process technology file) and the taper angle indicates an x-y location for the new 2-D shape. Some embodiments use the taper angle and thickness to calculate a distance in the x-y plane. This distance can then be measured in the direction orthogonal to the tangent of the initial 2-D shape in some embodiments to determine the x-y location for the new 2-D shape (either inwards or outwards, depending on the direction of the taper angle relative to the z-axis). The result of this process is another 2-D shape that is similar to the initial (selected) 2-D shape, but is (i) either smaller or larger, depending on the taper angle direction and (ii) located either above or below the initial 2-D shape along the z-axis by an amount defined by the wire thickness. For positive taper angles, the area of the lower 2-D shape will be smaller than that of the upper 2-D shape by an amount dependent on the taper angle. For negative taper angles, the area of the lower 2-D shape will be larger than that of the upper 2-D shape by an amount dependent on the taper angle. For positive taper angles, the lower 2-D shape in some embodiments underlaps the upper 2-D shape by an amount Z tan 0, where 0 is the taper angle and Z is the thickness of the component. Similarly, for negative taper angles, the lower 2-D shape overlaps the upper 2-D shape by this amount.

The process 1900 then connects (at 1925) the sidewall panels to construct a 3-D predicted manufactured shape for the currently selected 2-D shape. As noted, certain capacitance solvers require mesh inputs in a specific form defining each of the shapes. In this case, the layout verification tool can assemble these mesh inputs using the predicted manufactured shape.

In some embodiments, the 2-D shapes are defined in terms of pixels. Some such embodiments define pixels that are interior to a shape with a value of 1.0, pixels that are exterior to the shape with a value of 0 (or vice versa), and boundary pixels with a value between 0 and 1, depending on the extent of the pixel that is occupied by the shape. Thus, the boundary pixels for a given predicted 2-D shape are the pixels with values between 0 and 1. These boundary pixels can be translated into contours defined in terms of x-y locations (e.g., as polygons with each vertex given an x-y location).

The process 1900 then determines (at 1930) whether additional generated 2-D shapes remain for which the 3-D shapes need to be constructed. If additional shapes remain, the process 1900 returns to 1910 to select the next 2-D shape. Otherwise, the process 1900 ends, having generated the 3-D predicted manufactured shapes for the design layout region. At this point, the solver input can be constructed (if necessary) and the parasitic values computed for the design layout region.

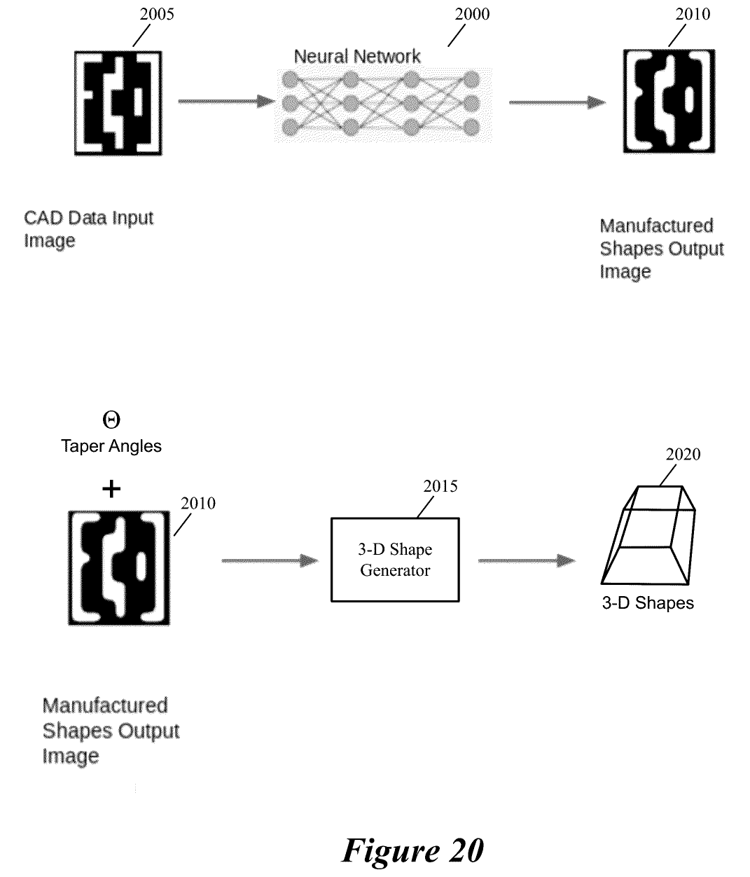

As indicated, some embodiments use machine-trained networks to generate the 2-D planar shapes for different process conditions, and then use taper angle information to generate the 3-D shapes (as in the process 1900). FIG. 20 conceptually illustrates this concept. A CAD data image 2005 (or other image indicating the design layout) is provided as input to a trained neural network 2000 (e.g., one of several neural networks trained for different sets of process conditions), which generates the 2-D planar as-manufactured shapes 2010 for that set of process conditions. These as-manufactured 2-D shapes 2010 as well as the taper angle for the specific set of process conditions (or the identified taper angles for each (x,y) location or each boundary pixel in the layout of as-manufactured 2-D shapes are then provided to a 3-D shape generator 2015, which generates the 3-D predicted manufactured shapes 2020 (e.g., using the process 1900 described above by reference to FIG. 19 or a similar process to determine 3-D shapes from 2-D shapes and taper angle information).

Some embodiments use the neural network models described in U.S. patent application Ser. Nos. 16/949,270 and 17/992,870, now published respectively as U.S. Patent Publications 2022/0128899 and 2023/0168660, which are incorporated herein by reference. These models receive as input an image representative of a user-edited layout design and generate as output the resulting silicon wafer contours that would be manufactured.

For different sets of process conditions, different neural networks may be used to generate different sets of 2-D shapes for different process condition sets, and the 3-D shape generator 2005 can then generate the cross sections using the appropriate taper angle(s) for each process condition set. In addition, any suitable combination of machine-trained networks (e.g., neural networks) and other algorithmic processes may be used to perform the operations described throughout the specification.

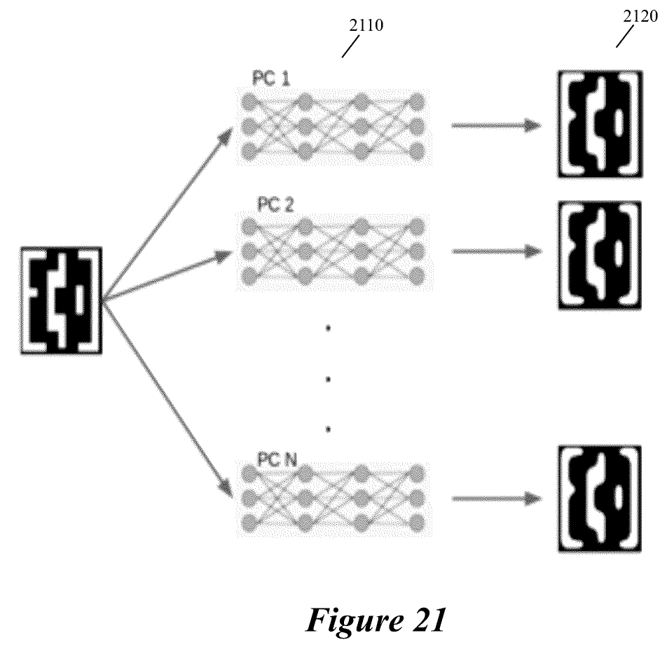

Instead of one neural network, other embodiments use N neural networks, with each neural network producing one of N different predicted output designs for one of N different process variations. For example, to deal with process variations, i.e., the case of multiple sets of process conditions each with their own taper angle, multiple copies of the single-output network may be produced in some embodiments, i.e., one network per unique set of process conditions (manufacturing parameter values), and each of these single-output networks may be trained in parallel. In some embodiments, each of these networks has the same structure, but with different parameter (e.g., weight, bias, etc.) values. FIG. 21 conceptually illustrates multiple networks 2110, each trained to generate a different set of outputs 2120 for a different set of process conditions corresponding to different manufacturing parameters. After training, each of these networks may be used to infer the output for that unique set of process conditions (i.e., that particular process condition set) for a given design layout input image.

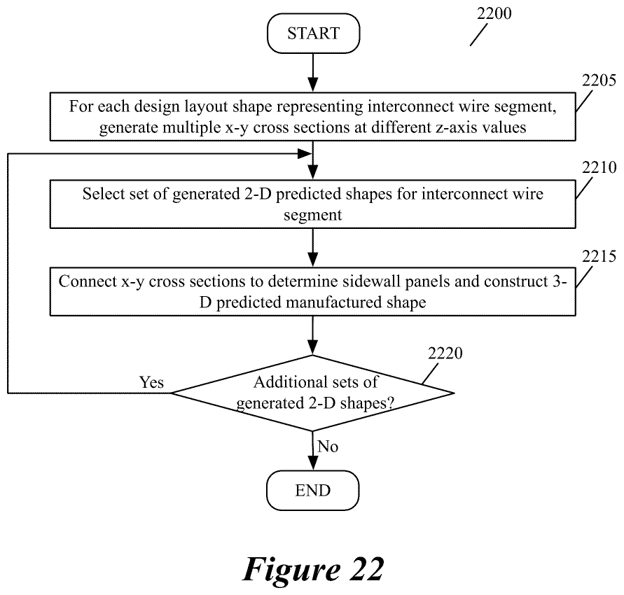

FIG. 22 conceptually illustrates a process 2200 of some embodiments for generating 3-D predicted manufactured shapes by initially generating multiple 2-D predicted manufactured shape for each interconnect wire segment and connecting these 2-D shapes to generate the 3-D predicted manufactured shapes. In some embodiments, the process 1900 is performed by a layout verification tool in order to more accurately compute parasitic values (e.g., capacitance values) for a region of an IC. In some embodiments, the process 2200 is performed at operation 1310 of the process 1300 or operation 1520 of the process 1500, both of which are described above.

As shown, the process 2200 begins by generating (at 1905), for each design layout shape representing an interconnect wire segment, multiple 2-D cross section shapes at different z-axis values. In some embodiments, this operation is performed for a given process condition set. The process 2200 is performed for each process condition set at which the parasitic values are evaluated, as noted in the description of the processes 1300 and 1500 above. The section of the design layout may be an entire layer of an IC, a portion of an IC layer (e.g., a region small enough for the 3-D shape information to be provided to a field solver, a specific portion of an IC layer that is selected by a chip designer, etc.). In some embodiments, the 2-D predicted manufactured shapes are generated based on design layout shapes representing interconnect wire segments for the design layout region. The design layout shapes may include rectilinear shapes (potentially in addition to curvilinear design layout shapes), while the predicted manufactured shapes will typically be curvilinear shapes to reflect the difficulty of actually manufacturing shapes with true straight lines (at a close enough resolution), as shown in FIG. 14.

More specifically, some embodiments directly generate “top” and “bottom” cross sections of the 3-D predicted manufactured shape for each interconnect wire segment. These cross sections, in some embodiments, are the shapes generated by the process 1900, but in this case the same operation is used to generate multiple 2-D shapes for each design layout shape (i.e., each interconnect wire segment). Some embodiments generate more than just the top and bottom cross sections for each design layout shape—e.g., the top, bottom, and middle, or in some cases more than three cross sections. For a given design layout shape, each of these generated cross sections will typically have a similar shape but will be a different size owing to the taper angle. In this case, the taper angle is either an input to the shape generation process (e.g., based on a technology process file) or is an inherent part of the shape generation process.

For instance, some embodiments use a neural network (or other machine-trained network) to generate the multiple 2-D predicted manufactured shapes for each interconnect wire segment. That is, in such embodiments, the design layout region is provided as input to the network and the network outputs the multiple 2-D predicted manufactured shapes for each design layout shape in that region. In some embodiments, the taper angle (or per-location angle) does not need to be input to the network, as the network will learn these angles during the training process. Other embodiments may use algorithmic processes, such as application of a corner rounding algorithm (e.g., using Gaussian smoothing, etc.) to generate the predicted manufactured shapes.

The process 2200 then selects (at 2210) a set of generated 2-D layout shapes for a particular interconnect wire segment. It should be understood that the process 2200 is a conceptual process, and that some embodiments may perform the operation 2215 for numerous interconnect wire segments in parallel rather than generating the 3-D predicted manufactured shapes one at a time.

Using the set of generated x-y planar cross sections at different z-axis locations, the process 2200 connects (at 2215) these shapes to determine the sidewall panels and construct a 3-D predicted manufactured shape for the currently selected interconnect wire segment. As noted, certain capacitance solvers require mesh inputs in a specific form defining each of the shapes. In this case, the layout verification tool can assemble these mesh inputs using the predicted manufactured shape. In some embodiments, the 2-D shapes are defined in terms of pixels. Some such embodiments define pixels that are interior to a shape with a value of 1.0, pixels that are exterior to the shape with a value of 0 (or vice versa), and boundary pixels with a value between 0 and 1, depending on the extent of the pixel that is occupied by the shape. Thus, the boundary pixels for a given predicted 2-D shape are the pixels with values between 0 and 1. These boundary pixels can be translated into contours defined in terms of x-y locations (e.g., as polygons with each vertex given an x-y location).

The process 2200 then determines (at 2220) whether additional sets of generated 2-D cross sections remain for which the 3-D shapes need to be constructed. If additional shapes remain, the process 2200 returns to 2210 to select the next set of 2-D cross sections. Otherwise, the process 2200 ends, having generated the 3-D predicted manufactured shapes for the design layout region. At this point, the solver input can be constructed (if necessary) and the parasitic values computed for the design layout region.

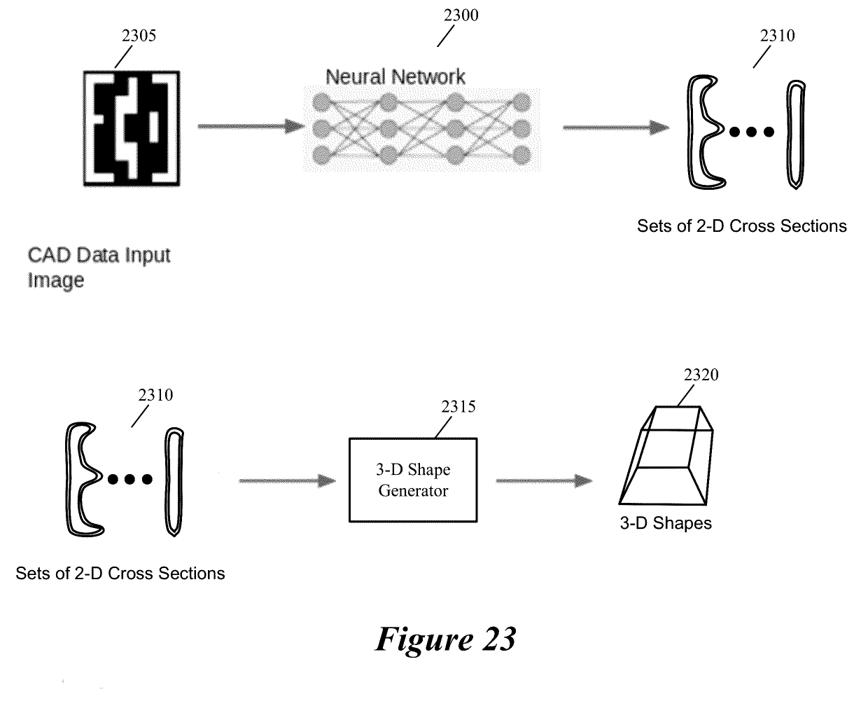

As indicated, some embodiments use machine-trained networks to generate the multiple 2-D cross sections for each design layout shape representing an interconnect wire segment for different process conditions, and then connect the cross sections for each shape to generate the 3-D shapes (as in the process 2200). FIG. 23 conceptually illustrates this concept. A CAD data image 2305 (or other design layout image) is provided as input to a trained neural network 2300 (e.g., one of several neural networks trained for different sets of process conditions), which generates sets of 2-D cross sections 2310 for each shape in the design layout. These as-manufactured 2-D cross sections 2310 are then provided to a 3-D shape generator 2315, which generates the 3-D predicted manufactured shapes 2320 (e.g., by connecting the sets of 2-D cross sections) with tapered sides.

As noted, some embodiments provide the neural network 2300 with taper angle information (i.e., either a constant taper angle, a set of taper angles for different process variations, or per-location (i.e., per x-y coordinate) taper angles) as input in addition to the design layout image 2305. In this case, the neural network is trained to output different sets of cross sections based on different taper angles. On the other hand, some embodiments only use the design layout input image 2305 as input to the neural network 2300. In this case, the neural network is trained by providing the network with data images as training inputs and known sets of manufactured (or simulated) cross sections (potentially at different process variations) for those training inputs. In this case, the network learns the correct taper angles (either constant or varying) for each shape based on various factors (the manufacturing process parameters, neighborhood effects, etc.).

Rather than generate 2-D cross sections (either one such cross section as in FIG. 19 or multiple as in FIG. 22) and construct 3-D predicted manufactured shapes from these cross sections, some embodiments directly generate the 3-D shapes without intermediate steps. Different embodiments may use a machine-trained network (e.g., a neural network) or another algorithmic process to directly generate the 3-D shapes.

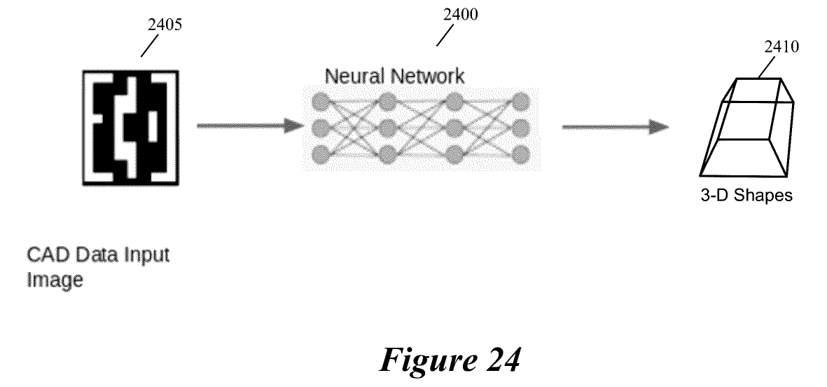

FIG. 24 conceptually illustrates the use of a neural network to directly generate the 3-D predicted manufactured shapes. A CAD data image 2405 (or other design layout image) is provided as input to a trained neural network 2400 (e.g., one of several neural networks trained for different sets of process conditions), which outputs the 3-D predicted manufactured shapes 2410 (with tapered sidewalls) for that set of process conditions.

In some embodiments, the design layout image 2405 (as well as the design layout images 2005 and 2305 described above) is a pixel (rasterized) image. In some embodiments, such a rasterized image includes white pixels for fully-filled pixels (e.g., pixels that are on the interior of a design layout shape), black pixels for fully-empty pixels (e.g., pixels that are located between design layout shapes), and grey pixels for partially-filled pixels (i.e., pixels that are on the boundary of a design layout shape). In some of these embodiments, fully filled pixels are represented with the numerical value 1.0, fully empty pixels are represented as 0.0, and partially filled pixels are represented with a value in the range [0,1] representative of the area of the pixel which is filled by the design layout shape (e.g., a pixel that is 50% filled will have a value of 0.5). A rasterized design layout image is also referred to as a pixel dose map, and the numerical values referred to as pixel dose values.

In some embodiments, the 2-D outputs of the neural networks (e.g., networks 2000 and 2300) are also pixel does maps (i.e., rasterized layout images). Similarly, the outputs of the network 2400 are voxels (3-D counterparts to 2-D pixels). Where a pixel represents a value on a grid in a 2-D space, a voxel represents a value on a 3-D grid. Like pixels, voxels are assigned values (e.g., RGB values if color is used, or values in the range [0,1] for greyscale. For the 3-D shapes 2410 output by the neural network 2400, in some embodiments voxels within a shape are represented by the value 1.0, voxels outside of the shapes are represented by the value 0.0, and boundary voxels are represented by values between 0 and 1. Some embodiments translate these voxels to a mesh of polygon vertices to provide input to a parasitic solver (e.g., a field solver).

As noted, some embodiments provide the neural network 2400 with taper angle information (i.e., either a constant taper angle, a set of taper angles for different process variations, or per-location (i.e., per x-y coordinate) taper angles) as input in addition to the design layout image 2405. In this case, the neural network is trained to output different 3-D shapes based on different taper angles. On the other hand, some embodiments only use the design layout input image 2405 as input to the neural network 2400. In this case, the neural network is trained by providing the network with data images as training inputs and known sets of manufactured (or simulated) 3-D shapes (potentially at different process variations) for those training inputs. In this case, the network learns the correct taper angles (either constant or varying) for each 3-D shape based on various factors (the manufacturing process parameters, neighborhood effects, etc.).

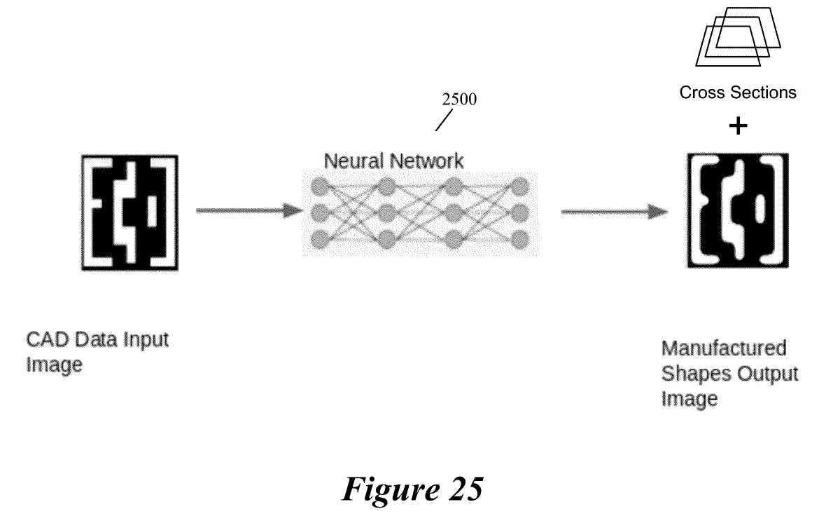

Yet other embodiments use a machine-trained network (e.g., a neural network) to generate 2-D planar shapes as well as a set of 2-D cross sections orthogonal to the 2-D planar shapes, from which 3-D shapes can be constructed. FIG. 25 conceptually illustrates the use of a neural network 2500 to produce an output image of predicted manufactured 2-D planar shapes as well as cross sections for an input image and set of input taper angles. FIG. 25 illustrates the use of a neural network 2500 used to infer manufactured shapes and cross sections of IC components from CAD (computer aided design) data input and taper angles of manufacturing process parameters. When neural networks are executed on modern GPU architectures, the inference time, even for relatively large designs, can be reduced to interactive time frames (i.e. within seconds). While some embodiments employ neural networks, other embodiments use other machine learning processes to formulate predictions as to the eventual shapes that would result once a design is manufactured.

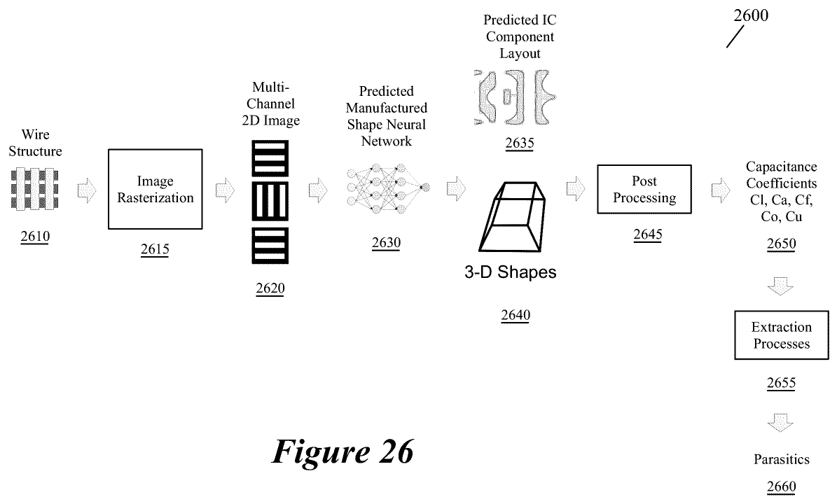

FIG. 26 conceptually illustrates a novel process 2600 to compute capacitance coefficients (or other parasitic values) for later use during extraction. Under this approach, at 2615, image rasterization is performed on a wire structure (design layout) 2610 to produce several 2-D images, which are referred to below as a multi-channel 2-D image 2620. Rasterization is the process of taking an image described in a geometrical/vector graphics format (shapes) and converting it into a raster image (a series of pixels, dots or lines, which, when displayed together, create the image which was represented via shapes).

The image rasterization defines the multi-channel 2-D image 2620 in the pixel domain (i.e., produces a pixel-based definition for the multi-channel 2-D image 2620). As such, instead of quantifying geometrical attributes and then using these attributes along with pre-characterized lookup table values to compute capacitances or other parasitic values, the approach illustrated in FIG. 26 uses pixel representations of the design to produce predicted manufactured shapes of the components in the wire structure 2610 that will be used to produce capacitance coefficients from which parasitic capacitances are computed (e.g., by accounting for wire segment lengths and/or wire segment overlapping lengths).

In some embodiments, the image rasterization produces white pixels for fully-filled pixels (e.g., pixels fully covered by a shape, such as wire segments), black pixels for fully-empty pixels (e.g., pixels not covering any shapes, such as wire segments), and grey pixels for partially-filled pixels. In some of these embodiments, fully-filled pixels are represented with the numerical value 1.0, fully-empty pixels are represented as 0.0, and partially-filled pixels are represented with a value in the range [0,1] representative of the area of the pixel which is filled by the wire (e.g., a pixel that is 50% filled will have a value of 0.5). Before rasterizing the wire structure, some embodiments decompose the wire structure into several components (e.g., several wires, wire segments or wire structure portions), which the process then individually rasterizes.

The multi-channel 2-D image 2620 is then used as the input to the predicted manufactured shape neural network 2630, which produces predicted IC component layout 2635 and/or 3-D shapes 2640. As described above, the neural network 2630 may output a set of 2-D predicted shapes from which the 3-D predicted manufactured shapes are generated (based on identified taper angles), a set of multiple 2-D predicted cross sections for each shape from which the 3-D predicted manufactured shapes are generated (by connecting these cross sections), or the 3-D predicted manufactured shapes directly.

Different 2-D plane shapes in the predicted IC component layout 2635 that are generated for a particular wire segment in the 2-D image 2620 in some embodiments correspond to different manufacturing process variations, such as different doses to account for mask variations, or different depth of focus and exposure strengths for wafer production variations. The different sets of cross sections 2640 that are generated in some embodiments also correspond to the different manufacturing process variations, more specifically to the different taper angles of the different manufacturing process variations. As noted above, some embodiments only use the neural network to generate the predicted 2-D IC component layout 2635, with the cross sections determined based on this layout and the taper angle.

The machined-trained network 2630 is referred to in some embodiments as the “digital twin” of a manufacturing process that produces a set of masks for a design or a wafer or IC die that is produced by using the set of masks. The predicted IC component layout 2635 produced by the machine-trained network 2630 is also referred to as the “digital twin” of the design that is produced by the set of masks or produced on the IC die/wafer.

In some embodiments, the predicted IC component layout 2635 and sets of cross section 2640 produced by the trained neural network 2630 are further post-processed into capacitance coefficients (e.g., per unit length capacitance coefficients). To this end, the predicted IC component layout 2635 and cross section sets 2640 are supplied to a post-processor 2645, which produces capacitance coefficients 2650 as output. As shown, these capacitance coefficients include Cl (lateral capacitance), Ca (area capacitance), Cf (fringe capacitance), Co, and Cu (all per unit length) in some embodiments, while in other embodiments they are post processed into other coefficients for other capacitance models. The post processor 2645 performs operations 1315 and 1320 of the process 1300 of FIG. 13 in some embodiments to produce the capacitance coefficients 2650.

To produce the capacitance coefficients 2650, the post-processor 2645 in some embodiments constructs simultaneous equations relating the capacitance matrix values to Cl, Ca and Cf capacitance component values, and solves these equations to produce Cl, Ca and Cf component values for that particular wire width and spacing, i.e., W, S pair. The approach is then repeated for various values of W, S. In some embodiments, the produced capacitance coefficients 2650 are parasitic values per unit length. In such embodiments, during extraction processes 2655, the produced capacitance coefficients 2650 are then used to compute parasitics 2660 (e.g., parasitic capacitances), for example, by multiplying these coefficients with length of overlapping wire segments.

In some embodiments, the parasitics 2660 computed from the capacitance coefficients 2650 are computed for each manufacturing process parameter (i.e., for each set of process conditions, including at least two of nominal, maximum, and minimum process conditions). In some of these embodiments, all parasitic values 2660 for all manufacturing process parameters are considered the extracted parasitics for the wire structure 2610. In other embodiments, a subset of parasitics for a subset of manufacturing process parameters is considered as the extracted parasitics for the wire structure 2610.

For example, some embodiments consider the worst computed parasitics as the parasitics for the wire structure 2610, as the worst parasitics consider the worst-case scenario of the wire structure 2610 when manufactured. As another example, some embodiments consider the average computed parasitics as the parasitics for the wire structure 2610, as the average parasitics consider the average scenario of the wire structure 2610 when manufactured. The average parasitics, in different embodiments, may be the median parasitics computed for the wire structure 2610 or the mean of the various parasitics computed for the wire structure 2610. Any suitable method may be used to determine which parasitics for which manufacturing process parameters are considered the extracted parasitics for the wire structure 2610.

Using the trained neural network 2630 to compute the predicted IC component layout 2635 and/or 3-D shapes 2640 is advantageous as this increases the level of accuracy in the capacitance coefficient calculation and parasitic extraction in addition to increasing the speed of such computations. This is because the predicted IC component layout 2635 includes 2-D plane shapes that represent the components of the wire structure 2610 as curvilinear shapes, while the 3-D shapes 2640 consider the taper angles 2625 of the manufacturing process. The neural network 2630 speeds up the computation time of the predicted IC component layout and/or 3-D predicted manufactured shape generation, which decreases the time taken to compute the parasitics 2660.

To train the neural network 2630, some embodiments use known input sets (e.g., known wire structures) with known output sets (e.g., as-manufactured IC component layouts with 2-D plane shapes of wire segments and/or corresponding cross sections for those known wire structures). During training, batches of known input sets are rasterized and fed through the neural network 2630 and post-processed to produce groups of output sets. The difference between each produced group of output sets and the known output sets of each group of known input sets is an error value that is propagated back through the neural network 2630 to train its trainable parameters (e.g., its weight values). This process is iterated upon many times (hundreds, thousands, or even millions of times), propagating input sets through the network and backpropagating the error to modify the trainable parameters. Some embodiments perform the training once per process technology in order to generate a different network for each process technology (i.e., once per process variation), and then perform the operations of FIG. 26 to perform the extraction once or more than once during the IC design process.

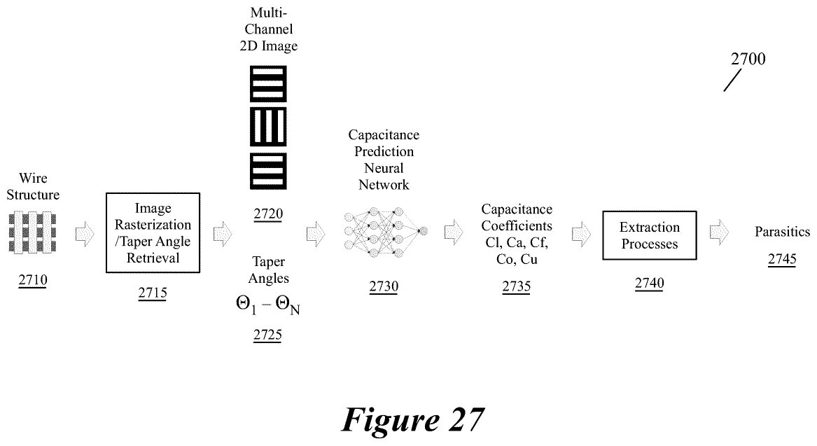

In some embodiments, a neural network is used to directly produce capacitance coefficients from input images and taper angles, rather than generating the predicted 3-D component shapes and using a field solver or other method to produce the capacitance coefficients (or the parasitics themselves) from the 3-D component shapes. FIG. 27 illustrates another novel approach 2700 to compute capacitance coefficients for later use during extraction. Under this approach, at 2715, image rasterization is performed on a wire structure 2710 to produce several 2-D images, which are referred to below as a multi-channel 2-D image 2720. The image rasterization defines the multi-channel 2-D image 2720 in the pixel domain (i.e., produces a pixel-based definition for the multi-channel 2-D image 2720).

At 2715, taper angle retrieval is also performed to retrieve the taper angles 2725 for the different process condition sets of the manufacturing parameters. In some embodiments, the number N of taper angles is equal to the number of process condition sets. For example, there are three taper angles when nominal, maximum, and minimum process condition sets are considered. In other embodiments, the taper angles vary and are identified for each location in the 2-D images. Yet other embodiments do not retrieve the taper angles, as these are not required as inputs to the neural network 2730.

The multi-channel 2-D image 2720 and taper angles 2725 are then used as the primary input to the capacitance prediction neural network 2730, which produces a set of capacitance coefficients 2735. In this example, the neural network 2730 receives the 2-D image 2720 and the taper angles 2725 as input and directly produces the capacitance coefficients 2735, rather than producing a predicted IC component layout with cross sections that would go through post processing to determine the capacitance coefficients 2735. In this example, the neural network 2730 provides the capacitance coefficients 2735 as output. The neural network 2730 may also provide a predicted IC component layout for each 2-D plane shape illustrated in the predicted IC component layout as output in some embodiments (i.e., in addition to the capacitance coefficients). In addition, some embodiments do not require the taper angles, as the neural network 2730 is trained using capacitance coefficient results that factor in taper angles and thus can use only the multi-channel 2-D image 2720 as input.

As shown, these capacitance coefficients include Cl, Ca, Cf, Co, and Cu per unit length in some embodiments, while in other embodiments they are post processed into other coefficients for other capacitance models. After the capacitance coefficients 2735 have been created, some embodiments perform extraction processes 2740 to produce parasitics 2745 (e.g., parasitic capacitances), for example, by multiplying these coefficients with length of overlapping wire segments.

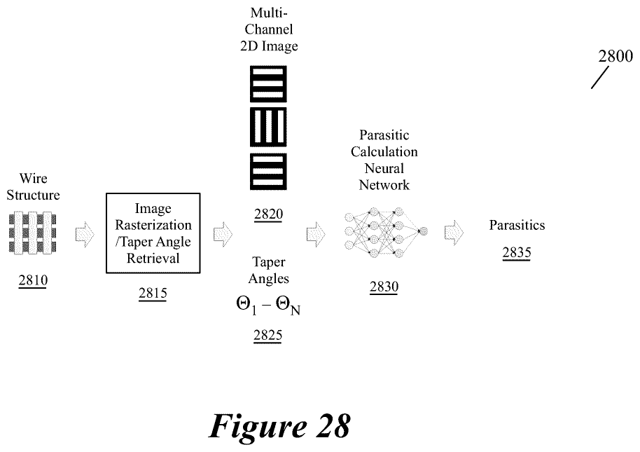

In some embodiments, a neural network is used to produce parasitics from input images and taper angles. FIG. 28 conceptually illustrates another novel approach 2800 of some embodiments to compute parasitics for a wire structure 2810. Under this approach, at 2815, image rasterization is performed on a wire structure 2810 to produce several 2-D images, which are referred to below as a multi-channel 2-D image 2820. The image rasterization defines the multi-channel 2-D image 2820 in the pixel domain (i.e., produces a pixel-based definition for the multi-channel 2-D image 2820).

At 2815, taper angle retrieval is also performed to retrieve the taper angles 2825 for the different process condition sets of the manufacturing parameters. In some embodiments, the number N of taper angles is equal to the number of process condition sets. For example, there are three taper angles when nominal, maximum, and minimum process condition sets are considered. In other embodiments, the taper angles vary and are identified for each location in the 2-D images. Yet other embodiments do not retrieve the taper angles, as these are not required as inputs to the neural network 2830.

The multi-channel 2-D image 2820 and taper angles 2825 are then used as the primary input to the parasitic calculation neural network 2830, which produces parasitics 2835 (e.g., parasitic capacitances) for the wire structure 2810. In this example, the neural network 2830 directly computes the parasitics 2835, rather than computing predicted manufactured shapes (including a predicted IC component layout with 2-D plane shapes and corresponding cross sections) or capacitance coefficients to use for post processing. In some other embodiments, the neural network 2830 may also provide the predicted manufactured shapes (e.g., 2-D plane shapes of IC components, cross sections) and/or capacitance coefficients as output. In addition, some embodiments do not require the taper angles, as the neural network 2830 is trained using parasitics results that factor in taper angles and thus can use only the multi-channel 2-D image 2820 as input.

As mentioned above, the machine-trained networks in some embodiments are neural networks. Some embodiments train a neural network to produce predicted manufactured shapes (e.g., 2-D plane shapes and/or 3-D predicted manufactured shapes) from a design layout by using many input data sets with known output data sets to train the configurable parameters (e.g., the weight values) of the neural network. The rectilinear wire shapes are used as the input values of each training set and the known 2-D plane curvilinear shapes and/or 3-D manufactured shapes are used as the output values of each training set. In some embodiments, the input/output sets are portions of IC designs for a particular IC manufacturing process (e.g., X nm designs) with the input portions being portions of physical designs produced by physical design tools, and output portions being the corresponding wafer simulation portion or circuit portion that is produced for the physical-design portion.

Some embodiments put machine-trained neural networks through learning processes that account for (1) manufacturing variations in one or more manufacturing parameters (such as dosage and focus depth), (2) angle variations (i.e., taper angles) corresponding to the different manufacturing variations, and/or (3) neighborhood variations that account for different possible neighboring component patterns that are part of the inputs used for the learning processes. To train the neural network, some embodiments feed each known input through the neural network to produce a predicted output, and then compare this predicted output to the known output of the input to identify a set of one or more error values. The error values for a group of known inputs/outputs are then used to compute a loss function, which is then back propagated through the neural network to train the configurable parameters (e.g., the weight values) of the neural network. Once trained by processing a large number of known inputs/outputs, the neural network can then be used to compute predicted 2-D plane shapes and cross sections of wire segments, e.g., according to any of the above-discussed operations that were described by reference to the above-described embodiments.

As indicated, in some embodiments the neighborhood of a component (e.g., for an interconnect wire segment) will affect the deviation of that component (from an ideal rectilinear shape with sides parallel to the z-axis) as manufactured. This deviation (the deformation or tapering) can include the 2-D cross sectional shape of the component (i.e., the planar shape in the x-y plane) having various curvilinear features rather than sharp right-angle corners as well as various different taper angles in the z-axis direction.

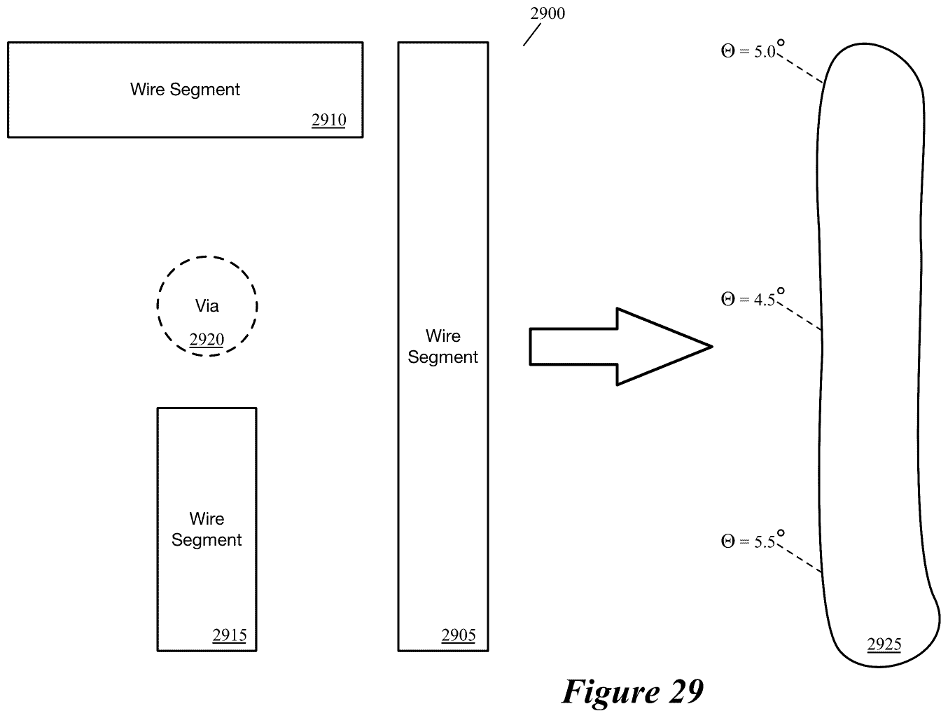

FIG. 29 conceptually illustrates a design layout 2900 with four components 2905-2920. These components include three wire segments 2905-2915 as well as a via 2920 (i.e., a via that runs through this metal layer to connect a lower metal layer to a higher metal layer). The figure also illustrates a predicted manufactured shape 2925 for the wire segment 2905. This predicted manufactured shape 2925 is shown in 2-D (i.e., a 2-D cross section) for simplicity, but the eventual predicted manufactured shape generated by the processes described above is a 3-D shape. The predicted manufactured shape 2925 has different taper angles indicated at different locations along its left side (i.e., 5.0° at the top, 4.5° in the middle, and 5.5° at the bottom). These different taper angles are due, at least in part, to the presence of the different neighboring components 2910-2920 nearby to the different areas of the wire segment 2905 in the design layout 2900. In some embodiments, (i) the proximity of the other component and/or (ii) the type of component have an effect on the deviation of a component's 2-D shape and/or the tapering in the third (z-axis) dimension. For instance, because the via 2920 runs the full thickness of the layer including wire segments 2905-2915, this can have an effect on the taper angle of the predicted manufactured shape 2925 (e.g., making the taper angle larger or, as in this case, smaller).

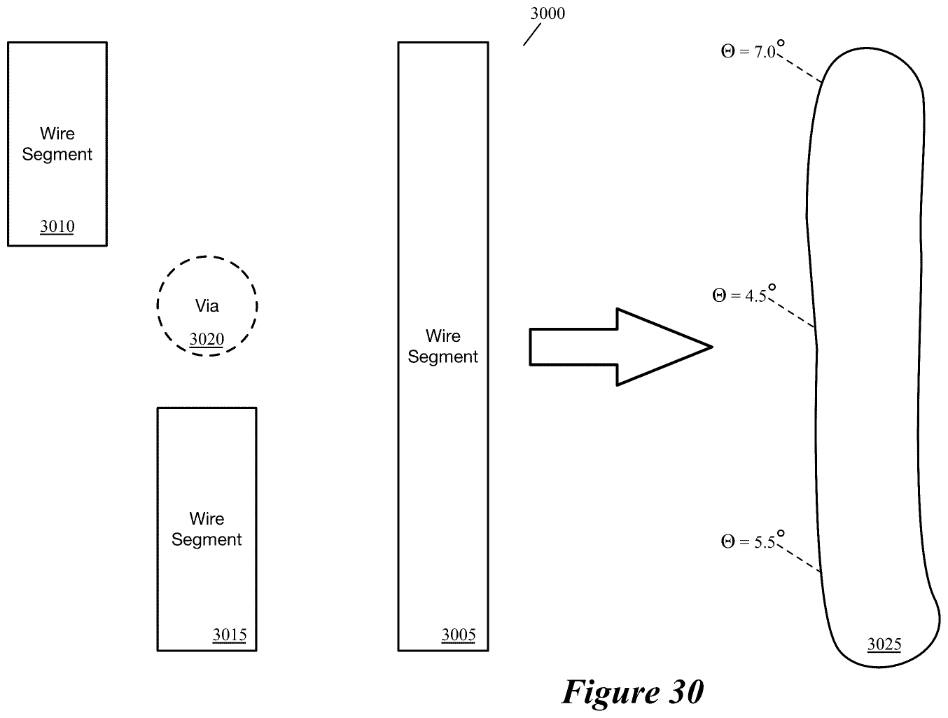

FIG. 30 conceptually illustrates a different design layout 3000 with four components 3005-3020. These components include three wire segments 3005-3015 as well as a via 3020 (i.e., a via that runs through this metal layer to connect a lower metal layer to a higher metal layer). These components differ from those shown in FIG. 29 only in that the wire segment 3010 runs parallel to the wire segments 3005 and 3015 and is further from the wire segment 3005. The figure also illustrates a predicted manufactured shape 3025 for the wire segment 3005. Owing to the wire segment 3010 being further away, the predicted manufactured shape 3025 is slightly larger towards its top than the predicted manufactured shape 2925. In addition, the taper angle near the top of this shape is now 7.0° at the top rather than 5.0°.

In some embodiments, the different taper angles are determined by a neural network or other algorithmic function. In some embodiments, this process (i.e., the neural network or other function) accounts for the neighborhood features of a given component when determining (i) the 2-D planar shape of the component and/or (ii) the taper angles or other variation along the z-axis at any point along the 2-D planar shape. In some embodiments, the neural networks (whether directly generating 3-D shapes or generating multiple 2-D planar shapes at different z-axis locations) accounts for these neighborhood affects when generating the output. Thus, the input to the neural networks includes the neighborhoods for each component (e.g., when inputting a CAD data image or other design layout image). The neural networks are trained to account for these neighborhood affects (by being trained with inputs that include the neighborhoods for each component and that have varied ground truth outputs based on the neighborhoods).

Previous embodiments for extracting capacitance assume cross sections of wire segments to be rectangular. They do not consider the taper angles of the manufacturing process parameters. Hence, the above-described embodiments that produce (e.g., using a machine-trained network) predicted 2-D plane shapes and tapered cross sections for wire segments allow for the creation of more accurate 3-D models. These 3-D models are then used as input to field solver tools to extract capacitances with a high level of accuracy. Curvilinear shapes of components in an IC design (e.g., wires) with tapered cross sections more closely resemble the manufactured shapes of these components. Hence, using tapered cross sections in addition to curvilinear shapes of IC components to perform parasitic extraction improves the accuracy of the extracted parasitic values.

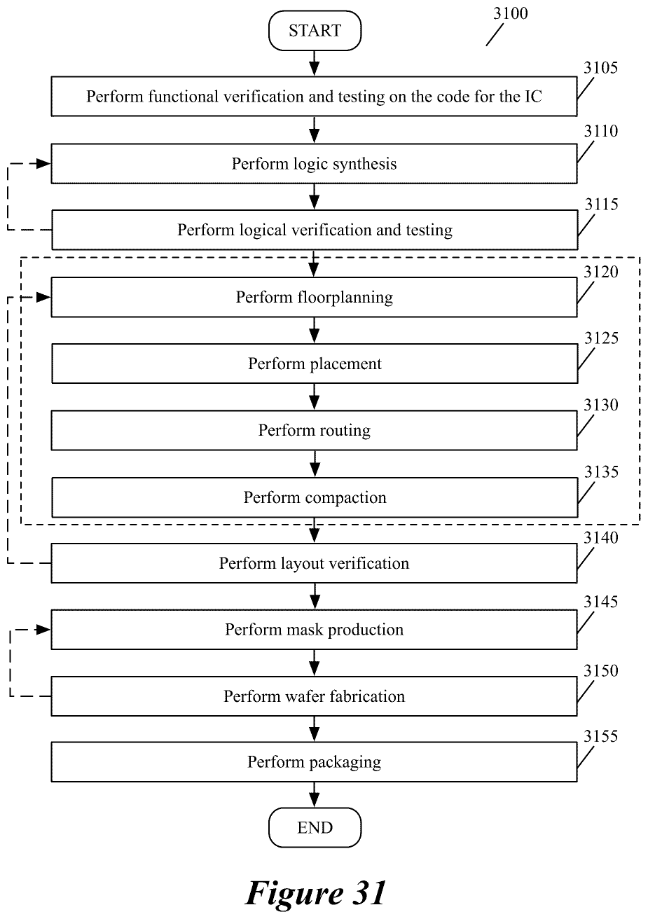

The above-described embodiments describe using predicted manufactured shapes including both 2-D plane shapes and cross sections of IC components to compute parasitics, such as capacitance. Parasitic extraction is one step in the overall process to design and manufacture an IC. FIG. 31 conceptually illustrates an example of one such process for designing and manufacturing an IC. The process 3100 of this figure uses the parasitic extraction techniques described above to ensure that the IC design layouts produced by the process do not violate one or more parasitic parameter thresholds.

The process 3100 begins (at 3105) by defining the code that specifies the IC design and performing functional verification and testing on this code. In some embodiments, the process uses one of the common hardware description languages (HDL) to specify the code. The HDL code in some embodiments describes the desired structure, behavior, and timing of the IC. To perform functional verification and testing on the code for the IC, some embodiments specify one or more modules and/or circuit components in the code and check the specified modules and/or circuit components for functional accuracy.

Next, the process 3100 performs (at 3110) a synthesis operation, which converts the HDL description into a circuit representation that commonly includes digital circuit components, such as logic gates, flip-flops, and other larger digital components (e.g., adders, multipliers, etc.). The synthesis operation is typically performed by a synthesis tool.

At 3115, the process 3100 performs verification and testing on the circuit representation that is produced by the synthesis operation. In some embodiments, the verification and testing checks the circuit representation to determine whether this representation meets desired timing constraints and satisfies any other constraint of the HDL code. When the verification and testing fails (e.g., if a portion of the circuit representation fails to meet a constraint), the process 3100 returns to step 3110 (as denoted by a dashed arrow line) to reperform synthesis to modify the circuit representation to resolve this failure.

When the verification and testing at 3115 passes, the process 3100 performs a set of physical design operations 3118, which include operations 3120-3135 between which the process 3100 can iterate through multiple times as further described below. At 3120, the process 3100 performs a floorplanning operation that defines a general location for some or all of the circuit blocks (e.g., for various large circuit blocks). For instance, in some embodiments, floorplanning divides the design layout into one or more sections devoted to different purposes (e.g., ALU, memory, decoding, etc.), and assigns some or all of the circuit blocks to these sections based on the purposes served by these blocks.

At 3125, the process 3100 performs a placement operation, which is based on the floorplanning data and defines a specific location and orientation in the design layout for each circuit block. The placement operation in some embodiments is an automated process that tries to find an optimal placement for each circuit block based on one or more optimization criteria, such as congestion or estimated length of interconnects (e.g., metal wires) needed for connecting the nets associated with the circuit blocks. A net in some embodiments includes a set of two or more pins of one or more circuit blocks that need to be connected electrically (e.g., through a set of wires, contacts, and/or vias). After performing the placement operation, the process 3100 might return to the floorplanning operation if it determines that the floorplanning should be revised to improve the result of the placement operation.

Once the placement operation is completed satisfactorily, the process performs (at 3130) a routing operation to define the route needed to connect each net (i.e., to connect each set of pins that needs to be interconnected). Each defined route includes one or more interconnect segments (also called wire segments) that traverse one or more interconnect layers (also called wiring layers), and one or more vias and/or contacts that connect pins and/or wire segments on different wiring layers.

To define the routes, some embodiments divide the routing operation into a global routing operation and a detailed routing operation. For each net, global routing defines a global route that more generally defines the route for the net (e.g., defines a general area in the design layout traversed by the route). For instance, in some embodiments, the global router divides an IC into individual global routing areas, called Gcells. Then, a global route (Groute) is created for each net by listing the global routing areas (the Gcells) that the Groute for the net should pass through.

The detailed routing defines the actual route for each net (e.g., the route that connects the set of pins that forms the net). As mentioned above, each defined route includes one or more interconnect segments that traverse one or more interconnect layers, and one or more vias and/or contacts that connect pins and/or wire segments on different interconnect layers. In performing its detailed routing operation, the detailed router of some embodiments uses the global router's Groute data, e.g., by biasing its detail route search for the net to the Groute regions traversed by the Groute defined by the global router.

During or after the detailed routing operation, the process 3100 performs a design rule check (DRC) operation to ensure that the defined routes do not violate design rules. One example of the design rule check that is done for a route is to ensure that the route is not closer than an acceptable minimum spacing requirement on each layer traversed by the route to another route or another component in the design layout on that layer. Routes that violate minimum spacing constraints can cause undue capacitance and, in some cases, electrical shorts on the IC.

The process 3100 in some embodiments can iterate through the global and detailed routing multiple times to identify better Groutes for some nets in order to improve the detailed routes for these nets or other nets. Also, the process 3100 in some embodiments can return from either of these routing operations to an earlier operation in the EDA flow (e.g., to the placement operation) in order to improve the results of this earlier operation to improve the routes defined by the later routing operation.

After routing, the process 3100 performs (at 3135) compaction operations. In some embodiments, the compaction operation compresses the design layout in one or more directions to decrease the size of the IC die (e.g., to decrease the two-dimensional area of the IC die) that would be manufactured based on the design layout. Reducing the size of the IC improves the performance of the IC in some embodiments. A compacted design layout also lowers costs of the ICs manufactured using the design layout by allowing more ICs to be produced for a given wafer size.

After the compaction operation, the process 3100 performs a layout verification operation (at 3140) to ensure that the compacted design layout (e.g., the compacted routes in this design) to ensure that the layout meets one or more verification criteria. This verification operation includes a DRC operation that ensures that the compacted design layout does not violate design rules. One example of the DRC that is done for a route is to ensure that the route is not closer than an acceptable minimum spacing requirement on each layer traversed by the route to another route or another component in the design layout on that layer. Other examples of the DRC include performing minimum area, minimum width, and maximum curvature of shapes (e.g., routes, pins, contacts, vias, or other components) of items in the design layout, as described above.

The layout verification in some embodiments includes other operations, such as extraction. Extraction in some embodiments computes parasitic values (e.g., parasitic capacitance values or parasitic inductance values) exerted on items (e.g., wire segments) in the design layout. In some embodiments, the extraction operation computes capacitance coefficients for one or more conductive components in the design layout (e.g., for each wire segment of a route, or for the entirety of each route, in the design layout), and uses the capacitance coefficients to compute parasitic influence (e.g., capacitance, resistance, or inductance) on the conductive component(s).

After the compaction operation at 3135 or the subsequent verification operation 3140, the process 3100 in some embodiments can return to an earlier operation in the EDA flow (e.g., to the placement operation, to the global routing operation, or to the detailed routing operation) in order to improve the results of this earlier operation to improve the compacted design defined by the later compaction operation. For instance, when the design is not verified at 3140 (e.g., if a problem with the design is detected during verification), the process 3100 returns to an earlier physical design operation 3120 to 3135 to reperform this physical design operation, and any subsequent physical design operation, for a portion or for the entire design layout. In some embodiments, the design layout that exists after the compaction operation and that passes the subsequent verification operation 3140 on this layout is the end result of the physical design process, is called the physical design layout, and is used as the input to the subsequent operations 3145-3155 that form the manufacturing sub-process of the process 3100.

In some embodiments, the physical design sub-process includes other operations that are not displayed in FIG. 31. These other operations are not displayed for purposes of brevity. Examples of such operations include partitioning, power planning, and clock tree synthesis (CTS). In some embodiments, partitioning divides the design layout into similar-sized subsets and ensures a minimum number of connections between subsections. Power planning defines the power delivery network (PDN) that includes the interconnects for delivery power from the power supply circuit to circuits defined by the IC design layout. CTS in some embodiments defines a clock delivery network for delivering one or more clock signals to circuits defined by the IC design layout. CTS in some embodiments also inserts buffers and/or inverters along the clock signal paths on the clock delivery network in order to balance the load and decrease or eliminate any clock skew or delay.

The manufacturing sub-process includes a mask production operation (at 3145) that is performed in some embodiments once the physical design verification operation (at 3140) is performed, and the physical design layout is verified to pass the one or more verification criteria. In some embodiments, mask production includes mask layout generation, mask simulation, and wafer simulation. Mask layout generation defines the mask layout using commonly known techniques, such as OPC (optical proximity correction) and/or ILT (inverse lithography technology) operations.

During or after the mask layout generation, the process 3100 performs an MRC operation to ensure that the shapes defined in the mask layout do not violate MRC rules. Examples of the MRC rules include minimum spacing, minimum width, maximum curvature, and minimum area for shapes in the mask layout.

The mask simulation operation simulates the production of the mask using the generated mask layout. Mask simulation includes operations such as mask data preparation (MDP) and Mask Process Correction (MPC) in some embodiments. MDP in some embodiments prepares the mask layout for a mask writer. This operation in some embodiments includes “fracturing” the data into trapezoids, rectangles, or triangles. MPC in some embodiments geometrically modifies the shapes and/or assigns doses to the shapes to make the resulting shapes on the mask closer to the desired shape. MDP may use as input the generated mask layout or the results of MPC. MPC may be performed as part of a fracturing or other MDP operation. Other corrections may also be performed as part of fracturing or other MDP operations. Also, in some embodiments, the mask simulation operation calculates several possible mask images by using charged particle beam simulation.

The wafer simulation operation in some embodiments calculates possible patterns that would be produced on the manufactured IC by using the masks that would be generated based on the mask layout. In some embodiments, the wafer simulation operation includes a lithography simulation that uses the calculated mask images. Additional description of the mask generation, mask simulation, and wafer simulation operations is provided in U.S. Pat. No. 8,719,739, entitled “Method and System for Forming Patterns Using Charged Particle Beam Lithography”, which is incorporated herein by reference.

After the wafer simulation is performed for a given mask layout, the produced wafer patterns are examined to determine whether the mask layout should be revised and/or to determine whether one or more physical design operations should be repeated in order to revise the physical design layout. In some embodiments, the wafer pattern examination involves comparing the produced simulated wafer pattern to an ideal target pattern (e.g., to ensure that the predicted wafer image is within a minimum deviation of the target wafer image).

Conjunctively, or alternatively, this examination involves performing DRC checks on the produced wafer patterns that are predicted to appear on the IC die by the wafer simulator. In some embodiments, the process 3100 can iteratively repeat the sub-operations (i.e., the mask layout generation, the mask simulation, and the wafer simulation) of the mask production operation 3145 in order to improve the quality of the overall generated mask or can return to one of the earlier physical design operations 3118, as described above.

Once the mask layout is generated and verified, the process 3100 generates the masks specified for all the layers of the IC based on the mask layout. Mask generation transforms each mask image (also referred to as a mask layer, in some embodiments) of the mask layout into one or more lithographic masks in some embodiments. Once the masks are generated, the process 3100 performs (at 3150) wafer fabrication, which uses the generated masks to manufacture multiple IC dies on an IC wafer (e.g., a silicon wafer). The masks for the substrate and each wiring layer are used to generate the devices and wiring on the substrate and each wiring layer of each IC die. Each IC die is usually tested. During the testing of the IC dies, if it is determined that the IC has a defect because of its design or its masks, the process 3100 has to return to an earlier operation to improve its design layout, its mask layout, or its mask production operation. Lastly, the process 3100 performs (at 3155) packaging, which places each IC die in one chip package. Packaging in some embodiments includes slicing a wafer into multiple IC dies and placing each die on a substrate, which is then encapsulated to form a chip package. After performing packaging, the process 3100 ends.

Although several embodiments were described above by reference to performing parasitic extraction to compute parasitic parameter values on IC designs used to design and/or manufacture an IC, one of ordinary skill will realize that other embodiments are used to perform parasitic extraction for design layouts that are created for designing and manufacturing silicon interposers (e.g., wiring patterns on silicon interposers).

Still other embodiments are used to design and manufacture other patterns on other types of substrates. For instance, some embodiments use the above-described parasitic extraction processes to verify the design layouts for designing displays such as flat-panel displays (e.g., monitors, televisions, glasses, etc.) or curved displays (e.g., displays for virtual reality or augmented reality headsets). Such design layouts define patterns of controllable pixels on a display substrate. Still other embodiments use the above-described parasitic extraction processes to check the design layouts for designing other patterns of other elements for other substrates. Examples of such other substrates include substrates used to manufacture micro-electromechanical (MEMS) and other such similar devices.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

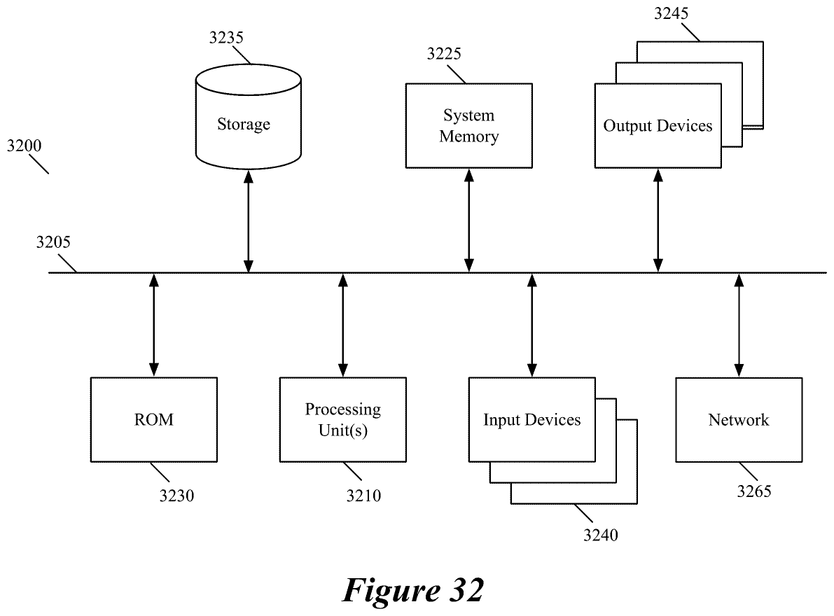

FIG. 32 conceptually illustrates a computer system 3200 with which some embodiments of the invention are implemented. The computer system 3200 can be used to implement any of the above-described computers and servers. As such, it can be used to execute any of the above-described processes. This computer system includes various types of non-transitory machine-readable media and interfaces for various other types of machine readable media. Computer system 3200 includes a bus 3205, processing unit(s) 3210, a system memory 3225, a read-only memory 3230, a permanent storage device 3235, input devices 3240, and output devices 3245.

The bus 3205 collectively represents all system, peripheral, and chipset buses that communicatively connect the numerous internal devices of the computer system 3200. For instance, the bus 3205 communicatively connects the processing unit(s) 3210 with the read-only memory 3230, the system memory 3225, and the permanent storage device 3235.

From these various memory units, the processing unit(s) 3210 retrieve instructions to execute and data to process in order to execute the processes of the invention. The processing unit(s) may be a single processor or a multi-core processor in different embodiments. In addition, some embodiments use graphics processing units (GPUs), tensor processing units (TPUs), and/or other accelerator processors, especially to execute the machine-trained networks described herein. The read-only-memory (ROM) 3230 stores static data and instructions that are needed by the processing unit(s) 3210 and other modules of the computer system. The permanent storage device 3235, on the other hand, is a read-and-write memory device. This device is a non-volatile memory unit that stores instructions and data even when the computer system 3200 is off. Some embodiments of the invention use a mass-storage device (such as a magnetic or optical disk and its corresponding disk drive) as the permanent storage device 3235.

Other embodiments use a removable storage device (such as a flash drive, etc.) as the permanent storage device. Like the permanent storage device 3235, the system memory 3225 is a read-and-write memory device. However, unlike storage device 3235, the system memory is a volatile read-and-write memory, such a random-access memory. The system memory stores some of the instructions and data that the processor needs at runtime. In some embodiments, the invention's processes are stored in the system memory 3225, the permanent storage device 3235, and/or the read-only memory 3230. From these various memory units, the processing unit(s) 3210 retrieve instructions to execute and data to process in order to execute the processes of some embodiments.

The bus 3205 also connects to the input and output devices 3240 and 3245. The input devices enable the user to communicate information and select commands to the computer system. The input devices 3240 include alphanumeric keyboards and pointing devices (also called “cursor control devices”). The output devices 3245 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 32, bus 3205 also couples computer system 3200 to a network 3265 through a network adapter (not shown). In this manner, the computer can be a part of a network of computers (such as a local area network (“LAN”), a wide area network (“WAN”), or an Intranet, or a network of networks, such as the Internet. Any or all components of computer system 3200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for performing an electronic design automation (EDA) operation with respect to a circuit component that is defined on a layer of an EDA design layout, the layer defined by (i) a plane defined along x- and y-axes and (ii) having a thickness along a z-axis, the method comprising:
using a wafer shape simulator to generate a plurality of two dimensional (2-D) shapes for the circuit component with each 2D shape representing a different predicted manufactured cross x-y section of the component at a different location along the z-axis;
using the plurality of 2-D shapes to generate, for the circuit component, a predicted-as-manufactured three dimensional (3-D) shape that deviates along the z-axis; and
performing an EDA operation for the circuit component using the predicted-as-manufactured 3-D shape.

2. The method of claim 1, wherein using the wafer shape simulator to directly generate the two or more 2-D shapes comprises providing at least a portion of the layer as input to a neural network that outputs the 2-D shapes.

3. The method of claim 2, wherein the neural network outputs two or more 2-D shapes for each circuit component in the region of the design layout.

4. The method of claim 2, wherein the neural network is trained by providing 2-D design layouts as input with ground truth outputs being cross sections of actual manufactured 3-D shapes for the 2-D design layout inputs.

5. The method of claim 2, wherein:
the portion of the layer is provided as input to the neural network as a rasterized pixel image of the layer portion; and
each of the 2-D shapes output by the neural network comprises a plurality of pixels that define the 2-D shapes for different z-axis locations.

6. The method of claim 5, wherein using the 2-D shapes to generate the 3-D shape comprises translating each respective plurality of pixels defining a respective one of the 2-D shapes into a respective set of vertices defining the respective 2-D shape.

7. The method of claim 1, wherein using the 2-D shapes to generate the 3-D shape comprises:
defining a first one of the 2-D shapes as a top of the 3-D shape and a second one of the 2-D shapes as a bottom of the 3-D shape, the top and bottom of the 3-D shape located the layer thickness apart along the z-axis; and
connecting the top and bottom of the 3-D shape.

8. The method of claim 1, wherein the deviation along the z-axis comprises having tapered sides that are not parallel to the z-axis.

9. The method of claim 8, wherein the tapered sides have a constant taper angle that offsets the sides from the z-axis by a constant amount.

10. The method of claim 8, wherein the tapered sides have a varying taper angle that offsets the sides from the z-axis by a varying amount.

11. The method of claim 1, wherein the plurality of 2-D shapes have different sizes in the x-y plane.

12. The method of claim 1, wherein performing the EDA operation comprises using the 3-D shape to compute a set of parasitic values for the circuit component that express parasitic effects on the circuit component based on one or more other circuit components in the design layout.

13. The method of claim 10, wherein using the 3-D shape to compute the set of parasitic values comprises providing the 3-D shape to an electromagnetic (EM) field solver along with generated 3-D shapes for the one or more other circuit components.

14. The method of claim 10, wherein the parasitic effects comprise parasitic capacitance values, wherein the EM field solver generates a capacitance matrix expressing parasitic effects between the circuit component and the one or more other conductive circuit components.

15. The method of claim 1, wherein the circuit component in the EDA design layout is a rectilinear 2-D shape and each of the generated 2-D shapes has at least one curvilinear feature.

16. A non-transitory machine-readable medium storing a program which when executed by at least one processing unit performs an electronic design automation (EDA) operation with respect to a circuit component that is defined on a layer of an EDA design layout, the layer defined by (i) a plane defined along x- and y-axes and (ii) having a thickness along a z-axis, the program comprising sets of instructions for:
using a wafer shape simulator to generate a plurality of two dimensional (2-D) shapes for the circuit component with each 2D shape representing a different predicted manufactured cross x-y section of the component at a different location along the z-axis;
using the plurality of 2-D shapes to generate, for the circuit component, a predicted-as-manufactured three dimensional (3-D) shape that deviates along the z-axis; and
performing an EDA operation for the circuit component using the predicted-as-manufactured 3-D shape.

17. The non-transitory machine-readable medium of claim 16, wherein the set of instructions for using the wafer shape simulator to directly generate the two or more 2-D shapes comprises a set of instructions for providing at least a portion of the layer as input to a neural network that outputs the 2-D shapes.

18. The non-transitory machine-readable medium of claim 17, wherein the neural network outputs two or more 2-D shapes for each circuit component in the region of the design layout.

19. The non-transitory machine-readable medium of claim 17, wherein the neural network is trained by providing 2-D design layouts as input with ground truth outputs being cross sections of actual manufactured 3-D shapes for the 2-D design layout inputs.

20. The non-transitory machine-readable medium of claim 17, wherein:
the portion of the layer is provided as input to the neural network as a rasterized pixel image of the layer portion;
each of the 2-D shapes output by the neural network comprises a plurality of pixels that define the 2-D shapes for different z-axis locations; and
the set of instructions for using the 2-D shapes to generate the 3-D shape comprises a set of instructions for translating each respective plurality of pixels defining a respective one of the 2-D shapes into a respective set of vertices defining the respective 2-D shape.
